(19) United States
(12) Patent Application Publication
(10) Pub. No.: US 2022/0017829 A1
(43) Pub. Date: Jan. 20, 2022

(54) SYSTEMS AND PROCESSES FOR DIRECT CONVERTING DISTILLATE FRACTIONS OF CRUDE OIL TO OLEFINS

(71) Applicant: Saudi Arabian Oil Company, Dhahran (SA)

(72) Inventors: Emad Naji Al-Shafei, Dhahran (SA); Mohammed Z. Al-Bahar, Dhahran (SA); Ali Nader Al-Jishi, Dhahran (SA); Ki-Hyouk Choi, Dhahran (SA); Mohammad F. Al-Jishi, Dhahran (SA); Ali S. Al-Nasir, Dhahran (SA)

(73) Assignee: Saudi Arabian Oil Company, Dhahran (SA)

(21) Appl. No.: 16/933,087

(22) Filed: Jul. 20, 2020

(51) Int. Cl. C10G 55/08; C10G 11/10; C10G 11/05; C10G 21/00; C10G 7/06; C10G 55/06

(52) U.S. Cl. CPC C10G 55/08; C10G 11/10; C10G 11/05; C10G 21/003; C10G 7/06; C10G 2300/807; C10G 2300/1037; C10G 2300/308; C10G 2300/70; C10G 2400/20; C10G 55/06

(57) ABSTRACT

A process for converting a hydrocarbon feed to olefins includes passing the hydrocarbon feed to a distillation system to separate the hydrocarbon feed to produce a light gas stream, a plurality of distillate fractions, and a residue. The process further includes passing at least one of the distillate fractions to a steam catalytic cracking system that includes at least one steam catalytic cracking reactor that is a fixed bed reactor containing a nano-zeolite cracking catalyst. The steam catalytic cracking system contacts the one or more of the plurality of distillate fractions with steam in the presence of the nano-zeolite cracking catalyst, which causes steam catalytic cracking of at least a portion of hydrocarbons in the at least one distillate fraction to produce a steam catalytic cracking effluent comprising the olefins.

### BACKGROUND

### Field

The present disclosure relates to systems and processes for separating and upgrading petroleum-based hydrocarbons, in particular, systems and processes for separation and upgrading hydrocarbon feeds through steam catalytic cracking.

### Technical Background

The worldwide increasing demand for light olefins remains a major challenge for many integrated refineries. In particular, the production of some valuable light olefins such as ethylene, propene, and butenes has attracted increased attention as purified olefin streams are considered the building blocks for polymer synthesis. The production of light olefins depends on several process variables, such as the feed type, operating conditions, and the type of catalyst. Despite the options available for producing a greater yield of propene and light olefins, intense research activity in this field is still being conducted.

Petrochemical feeds, such as crude oils, can be converted to petrochemicals, such as fuel blending components and chemical products and intermediates such as olefins and aromatic compounds, which are basic intermediates for a large portion of the petrochemical industry. Crude oil is conventionally processed by distillation followed by various reforming, solvent treatments, and hydroconversion processes to produce a desired slate of fuels, lubricating oil products, chemicals, chemical feedstocks and the like. An example of a conventional refinery process includes distillation of crude oil by atmospheric distillation to recover gas oil, naphtha, gaseous products, and an atmospheric residue. Streams recovered from crude oil distillation at the boiling point of fuels have customarily been further processed to produce fuel components or greater valuable chemical products or intermediates.

Conventional refinery systems generally combine multiple complex refinery units with petrochemical plants. For example, conventional refinery systems employs atmospheric and vacuum distillation of crude oil followed by hydrocracking units to produce naphtha, Liquefied Petroleum Gas (LPG), and other light fractions. Then, these materials are further processed in a steam cracker, a naphtha cracker, a reformer unit for benzene, toluene, and xylenes (BTX) production, a fluidized catalytic cracking unit, or a combination of these to produce petrochemical products, such as olefins.

### SUMMARY

Despite conventional refinery systems available for producing petrochemical products and intermediates from hydrocarbon feeds, these complex refinery systems often require many different unit operations for conversion of hydrocarbon feeds to greater value petrochemical products and intermediates, such as olefins.

Accordingly, there is an ongoing need for systems and processes to convert hydrocarbon feeds to olefins without the complexity of combining several refinery units. These needs are met by embodiments of the systems and processes for converting hydrocarbon feeds to olefins described in the present disclosure. The processes of the present disclosure include separating the hydrocarbon feed through a distillation system to produce a light gas stream, a plurality of distillate fractions, and a residue. The processes of the present disclosure further include steam catalytic cracking at least one of the distillate fractions in the presence of steam and a nano-zeolite cracking catalyst disposed in at least one fixed bed steam catalytic cracking reactor to produce a steam cracking effluent comprising olefins. The systems and processes of the present disclosure utilize simple crude oil topping distillation prior to direct conversion of the distillate fractions to olefins through steam catalytic cracking. Accordingly, the systems and processes of the present disclosure increase yield and production of greater valuable products and intermediates, such as olefins, with fewer unit operations and processing steps, such as various combinations of hydrotreating units, reformers, hydrotreating units, aromatic recovery complexes, hydrocracking units, or fluidized catalytic cracking units. The systems and processes of the present disclosure may also increase yields of other valuable petrochemical products and intermediates, such as but not limited to gasoline blending components, benzene, toluene, xylenes, or combinations of these.

According to one or more aspects of the present disclosure, a process for converting a hydrocarbon feed to olefins may include passing the hydrocarbon feed to a distillation system to separate the hydrocarbon feed to produce a light gas stream, a plurality of distillate fractions, and a residue. The process may further include passing at least one of the distillate fractions to a steam catalytic cracking system that may include at least one steam catalytic cracking reactor that may be a fixed bed reactor containing a nano-zeolite cracking catalyst. The steam catalytic cracking system may contact the one or more of the plurality of distillate fractions with steam in the presence of the nano-zeolite cracking catalyst, which may cause steam catalytic cracking of at least a portion of hydrocarbons in the at least one distillate fraction to produce a steam catalytic cracking effluent comprising olefins.

According to one or more other aspects of the present disclosure, a process for converting a hydrocarbon feed to olefins may include passing the hydrocarbon feed to a distillation system to separate the hydrocarbon feed to produce a light gas stream, a plurality of distillate fractions, and a residue, and passing at least one distillate fraction of the plurality of distillate fractions to a steam catalytic cracking system that may include at least one steam catalytic cracking reactor that may be a fixed bed reactor containing a nano-zeolite cracking catalyst. The steam catalytic cracking system may contact the one or more of the plurality of distillate fractions with steam in the presence of the nano-zeolite cracking catalyst to cause steam catalytic cracking of at least a portion of hydrocarbons in the at least one distillate fraction to produce a steam catalytic cracking effluent comprising olefins.

According to still other aspects of the present disclosure, a system for converting a hydrocarbon feed to olefins may include a distillation system that may be operable to separate the hydrocarbon feed to produce a light gas stream, a plurality of distillate fractions, and a residue, and a steam catalytic cracking system downstream of the distillation system. The steam catalytic cracking system may include at least one steam catalytic cracking reactor that may be a fixed bed reactor comprising a nano-zeolite cracking catalyst. The at least one steam catalytic cracking reactor may be operable to contact one or more of the distillate fractions with steam in the presence of the nano-zeolite cracking catalyst to produce a steam cracking effluent comprising olefins.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a generalized flow diagram of a system for separating and upgrading crude oil, according to one or more embodiments shown and described in this disclosure;

FIG. 2 schematically depicts a generalized flow diagram of a steam catalytic cracking system of the system for separating and upgrading crude oil in FIG. 1, according to one or more embodiments shown and described in this disclosure;

FIG. 3 schematically depicts a generalized flow diagram of another embodiment of a system for separating and upgrading crude oil, according to one or more embodiments shown and described in this disclosure;

FIG. 4 schematically depicts a generalized flow diagram of still another embodiment of a system for separating and upgrading crude oil, according to one or more embodiments shown and described in this disclosure;

FIG. 5 schematically depicts a generalized flow diagram of another embodiment of a system for separation and upgrading crude oil, according to one or more embodiments shown and described in this disclosure;

FIG. 6 schematically depicts a generalized flow diagram of another embodiment of a system for separation and upgrading crude oil, according to one or more embodiments shown and described in this disclosure;

FIG. 7 schematically depicts a generalized flow diagram of another embodiment of a system for separation and upgrading crude oil, according to one or more embodiments shown and described in this disclosure;

FIG. 8 schematically depicts a generalized flow diagram of another embodiment of a system for separation and upgrading crude oil, according to one or more embodiments shown and described in this disclosure; and

FIG. 9 schematically depicts a generalized flow diagram of another embodiment of a system for separation and upgrading crude oil, according to one or more embodiments shown and described in this disclosure.

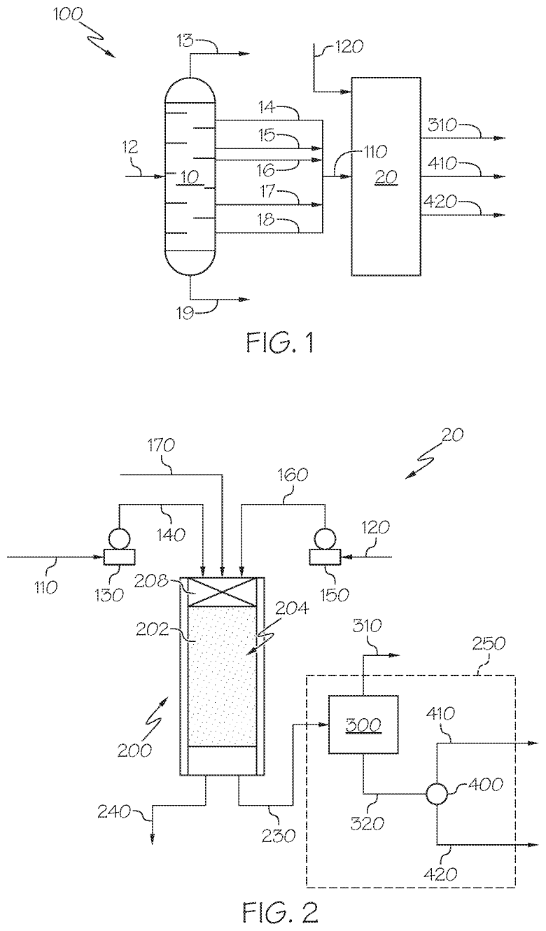

For the purpose of describing the simplified schematic illustrations and descriptions of FIGS. 1-9, the numerous valves, temperature sensors, pressure sensors, electronic controllers, pumps, and the like that may be employed and well known to those of ordinary skill in the art of certain chemical processing operations are not included. Further, accompanying components that are often included in chemical processing operations, such as, for example, air supplies, heat exchangers, surge tanks, compressors, or other related systems are not depicted. It would be known that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines, which may serve to transfer process steams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows, which do not connect two or more system components, signify a product stream, which exits the depicted system, or a system inlet stream, which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

It should be understood that two or more process streams are “mixed” or “combined” when two or more lines intersect in the schematic flow diagrams of FIGS. 1-9. Mixing or combining may also include mixing by directly introducing both streams into the same reactor, separation device, or other system component. For example, it should be understood that when two streams are depicted as being combined directly prior to entering a separation unit or reactor, that in some embodiments the streams could equivalently be introduced into the separation unit or reactor individually and be mixed in the reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

The present disclosure is directed to systems and methods for separating and upgrading hydrocarbon feeds, such as crude oil, to produce more valuable products and chemical intermediates, such as olefins. Referring to FIG. 1, one embodiment of a system 100 for upgrading a hydrocarbon feed 12 comprising crude oil or other heavy oil is schematically depicted. The system 100 may include a distillation system comprising one or more distillation units, such as atmospheric distillation unit (ADU) 10, a vacuum distillation unit (VDU), or both, which may separate the hydrocarbon feed 12 into at least a light gas stream 13, a plurality of distillate fractions 14, 15, 16, 17, 18 and a residue 19. The system 100 may further include a steam catalytic cracking system 20 disposed downstream of the distillation system. The steam catalytic cracking system 20 may include at least one steam catalytic cracking reactor that may be a fixed bed steam catalytic cracking reactor. The steam catalytic cracking reactor of the steam catalytic cracking system 20 may be operable to contact one or more of the distillate fractions with steam in the presence of a nano-zeolite cracking catalyst, the contacting causing at least a portion of the distillate fractions to react to form a steam cracking effluent 24 comprising olefins, such as but not limited to ethylene, propylene, butenes, or combinations of these.

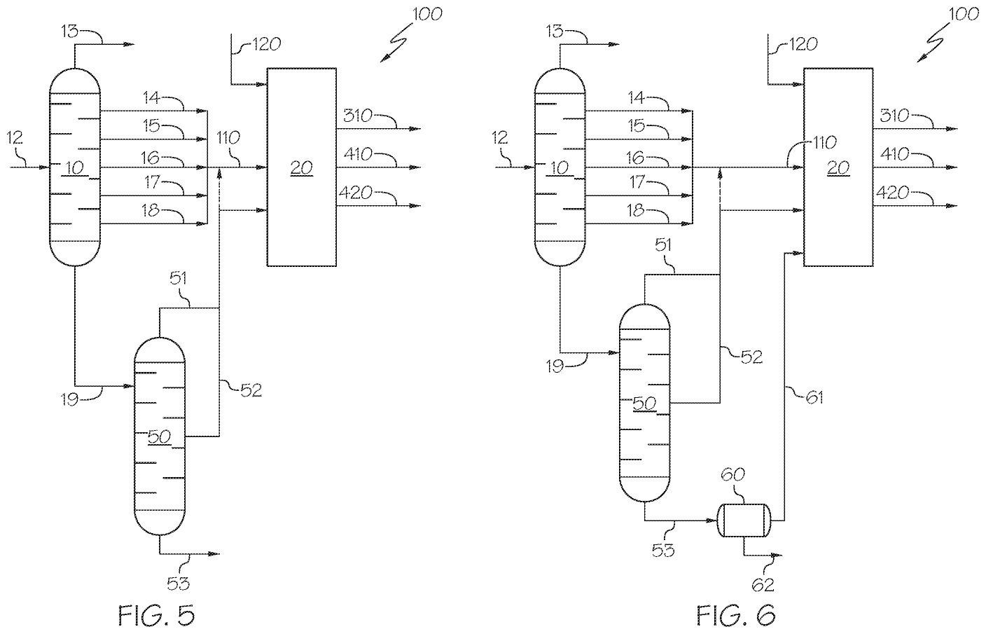

The system 100 may be utilized in a process for separating and upgrading the hydrocarbon feed 12. The process for converting the hydrocarbon feed 12 may include separating the hydrocarbon feed 12 through the distillation system that may include the ADU 10, the VDU 50 (FIG. 5), or both, which may separate the hydrocarbon feed 12 into at least the light gas stream 13, the plurality of distillate fractions 14, 15, 16, 17, 18, and the residue 19. The process may further include steam catalytic cracking at least one of the distillate fractions 14, 15, 16, 17, 18 in the presence of steam and a nano-zeolite cracking catalyst disposed in the steam catalytic cracking system 20 that may include at least one steam catalytic cracking reactor to produce a steam cracking effluent 24 comprising olefins.

The systems and processes of the present disclosure utilize simple crude oil topping distillation and require only one or few steps of crude oil distillation, prior to direct catalytic conversion of one or a plurality of the distillate fractions to olefins. Accordingly, the systems and processes of the present disclosure may increase yield and production of valuable products and intermediates, such as olefins including ethylene, propylene, butenes, or combinations of these, with less equipment and process units, such as hydrotreating units, hydrocracking units, fluidized catalytic cracking units, or combinations of these. The steam catalytic cracking system 20 may use 10 to 50 times less catalyst and may be operated with a longer time on stream compared to fluidized catalytic cracking units for producing olefins, among other benefits.

As used in this disclosure, a “reactor” refers to any vessel, container, or the like, in which one or more chemical reactions may occur between one or more reactants optionally in the presence of one or more catalysts. For example, a reactor may include a tank or tubular reactor configured to operate as a batch reactor, a continuous stirred-tank reactor (CSTR), or a plug flow reactor. Example reactors include packed bed reactors, such as fixed bed reactors, and fluidized bed reactors. As used in the present disclosure, the term “fixed bed reactor” may refer to a reactor in which a catalyst is confined within the reactor in a reaction zone in the reactor and is not circulated continuously through a reactor and regenerator system.

As used in this disclosure, one or more “reaction zones” may be disposed within a reactor. As used in this disclosure, a “reaction zone” refers to an area in which a particular reaction takes place in a reactor. For example, a packed bed reactor with multiple catalyst beds may have multiple reaction zones, in which each reaction zone is defined by the area of each catalyst bed.

As used in this disclosure, a “separation unit” refers to any separation device that at least partially separates one or more chemicals in a mixture from one another. For example, a separation unit may selectively separate different chemical species from one another, forming one or more chemical fractions. Examples of separation units include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation. As used in this disclosure, one or more chemical constituents may be “separated” from a process stream to form a new process stream. Generally, a process stream may enter a separation unit and be divided or separated into two or more process streams of desired composition.

As used in this disclosure, the term “fractionation” may refer to a process of separating one or more constituents of a composition in which the constituents are divided from each other during a phase change based on differences in properties of each of the constituents. As an example, as used in this disclosure, “distillation” refers to separation of constituents of a liquid composition based on differences in the boiling point temperatures of constituents of a composition, either at atmospheric conditions or under negative pressure. As used in this disclosure, the term “vacuum distillation” may refer to distillation conducted under a negative pressure relative to atmospheric pressure.

As used in this disclosure, the terms “upstream” and “downstream” may refer to the relative positioning of unit operations with respect to the direction of flow of the process streams. A first unit operation of the system 100 may be considered “upstream” of a second unit operation if process streams flowing through the system 100 encounter the first unit operation before encountering the second unit operation. Likewise, a second unit operation may be considered “downstream” of the first unit operation if the process streams flowing through the system 100 encounter the first unit operation before encountering the second unit operation.

As used in the present disclosure, passing a stream or effluent from one unit “directly” to another unit may refer to passing the stream or effluent from the first unit to the second unit without passing the stream or effluent through an intervening reaction system or separation system that substantially changes the composition of the stream or effluent. Heat transfer devices, such as heat exchangers, preheaters, coolers, condensers, or other heat transfer equipment, and pressure devices, such as pumps, pressure regulators, compressors, or other pressure devices, are not considered to be intervening systems that change the composition of a stream or effluent. Combining two streams or effluents together also is not considered to comprise an intervening system that changes the composition of one or both of the streams or effluents being combined. Surge vessels are also not considered to be intervening systems that change the composition of a stream or effluent.

As used in this disclosure, the term “initial boiling point” or “IBP” of a composition may refer to the temperature at which the constituents of the composition with the least boiling point temperatures begin to transition from the liquid phase to the vapor phase. As used in this disclosure, the term “end boiling point” or “EBP” of a composition may refer to the temperature at which the greatest boiling temperature constituents of the composition transition from the liquid phase to the vapor phase. A hydrocarbon mixture may be characterized by a distillation profile expressed as boiling point temperatures at which a specific weight percentage of the composition has transitioned from the liquid phase to the vapor phase.

As used in this disclosure, the term “atmospheric boiling point temperature” may refer to the boiling point temperature of a compound at atmospheric pressure.

As used in this disclosure, the term “effluent” may refer to a stream that is passed out of a reactor, a reaction zone, or a separation unit following a particular reaction or separation. Generally, an effluent has a different composition than the stream that entered the separation unit, reactor, or reaction zone. It should be understood that when an effluent is passed to another system unit, only a portion of that system stream may be passed. For example, a slip stream may carry some of the effluent away, meaning that only a portion of the effluent may enter the downstream system unit. The term “reaction effluent” may more particularly be used to refer to a stream that is passed out of a reactor or reaction zone.

As used in this disclosure, the term “catalyst” may refer to any substance that increases the rate of a specific chemical reaction. Catalysts described in this disclosure may be utilized to promote various reactions, such as, but not limited to, steam cracking. However, some catalysts described in the present disclosure may have multiple forms of catalytic activity, and calling a catalyst by one particular function does not render that catalyst incapable of being catalytically active for other functionality.

As used in this disclosure, the term “cracking” generally refers to a chemical reaction where a molecule having carbon-carbon bonds is broken into more than one molecule by the breaking of one or more of the carbon-carbon bonds; where a compound including a cyclic moiety, such as an aromatic compound, is converted to a compound that does not include a cyclic moiety; or where a molecule having carbon-carbon double bonds are reduced to carbon-carbon single bonds.

As used in this disclosure, the term “crystal size” may refer to an average particle diameter of nano-zeolite cracking catalyst when the nano-zeolite cracking catalyst is in the form of spherical particles, or may refer to a length of a major axis of nano-zeolite cracking catalyst when the nano-zeolite cracking catalyst is not in a spherical form, for example, in the form of non-spherical particles.

As used in this disclosure, the term “crude oil” or “whole crude oil” is to be understood to mean a mixture of petroleum liquids, gases, or combinations of liquids and gases, including, in some embodiments, impurities such as but not limited to sulfur-containing compounds, nitrogen-containing compounds, and metal compounds, that have not undergone significant separation or reaction processes. Crude oils are distinguished from fractions of crude oil. In certain embodiments, the crude oil feedstock may be a minimally treated light crude oil to provide a crude oil feedstock having total metals (Ni+V) content of less than 5 parts per million by weight (ppmw) and Conradson carbon residue of less than 5 wt. %.

It should further be understood that streams may be named for the components of the stream, and the component for which the stream is named may be the major component of the stream (such as comprising from 50 wt. %, from 70 wt. %, from 90 wt. %, from 95 wt. %, from 99 wt. %, from 99.5 wt. %, or even from 99.9 wt. % of the contents of the stream to 100 wt. % of the contents of the stream). It should also be understood that components of a stream are disclosed as passing from one system component to another when a stream comprising that component is disclosed as passing from that system component to another. For example, a disclosed “hydrogen stream” passing to a first system component or from a first system component to a second system component should be understood to equivalently disclose “hydrogen” passing to the first system component or passing from a first system component to a second system component.

Referring now to FIG. 1, an embodiment of the system 100 for separating and upgrading the hydrocarbon feed 12 is schematically depicted. As previously discussed, the system 100 may include one or more distillation units, such as the ADU 10. The system 100 may further include the steam catalytic cracking system 20 downstream of the distillation system. The system 100 may further include a solvent deasphalting unit 40 as shown in FIG. 4, a vacuum distillation unit (VDU) 50 as shown in FIG. 5, a steam cracking unit 80 as shown in FIG. 8, or combinations of these.

Referring again to FIG. 1, the hydrocarbon feed 12 may include one or more heavy oils, such as but not limited to crude oil, bitumen, oil sand, shale oil, coal liquids, vacuum residue, tar sands, other heavy oil streams, or combinations of these. It should be understood that, as used in this disclosure, a “heavy oil” may refer to a raw hydrocarbon, such as whole crude oil, which has not been previously processed through distillation, or may refer to a hydrocarbon oil, which has undergone some degree of processing prior to being introduced to the system 100 as the hydrocarbon feed 12. The hydrocarbon feed 12 may have a density of greater than or equal to 0.80 grams per milliliter. The hydrocarbon feed 12 may have an end boiling point (EBP) of greater than 565° C. The hydrocarbon feed 12 may have a concentration of nitrogen of less than or equal to 3000 parts per million by weight (ppmw).

In embodiments, the hydrocarbon feed 12 may be a crude oil, such as whole crude oil, or synthetic crude oil. The crude oil may have an American Petroleum Institute (API) gravity of from 25 degrees to 50 degrees. For example, the hydrocarbon feed 12 may include a light crude oil, a heavy crude oil, or combinations of these. Example properties for an exemplary grade of Arab light crude oil are listed in Table 1.

TABLE 1
Example of Arab Light Export Feedstock

| Analysis | Units | Value | Test Method |
|---|---|---|---|
| American Petroleum | degree | 33.13 | ASTM D287 |
| Institute (API) gravity | | | |
| Density | grams per milliliter | 0.8595 | ASTM D287 |
| | (g/mL) | | |
| Carbon Content | weight percent (wt. %) | 85.29 | ASTM D5291 |
| Hydrogen Content | wt. % | 12.68 | ASTM D5292 |
| Sulfur Content | wt. % | 1.94 | ASTM D5453 |
| Nitrogen Content | parts per million by | 849 | ASTM D4629 |
| | weight (ppmw) | | |
| Asphaltenes | wt. % | 1.2 | ASTM D6560 |
| Micro Carbon Residue | wt. % | 3.4 | ASTM D4530 |
| (MCR) | | | |
| Vanadium (V) Content | ppmw | 15 | IP 501 |
| Nickel (Ni) Content | ppmw | 12 | IP 501 |
| Arsenic (As) Content | ppmw | 0.04 | IP 501 |

Boiling Point Distribution

| | | | |
|---|---|---|---|
| Initial Boiling Point | Degrees Celsius (° C.) | 33 | ASTM D7169 |
| (IBP) | | | |
| 5% Boiling Point (BP) | ° C. | 92 | ASTM D7169 |
| 10% BP | ° C. | 133 | ASTM D7169 |
| 20% BP | ° C. | 192 | ASTM D7169 |
| 30% BP | ° C. | 251 | ASTM D7169 |
| 40% BP | ° C. | 310 | ASTM D7169 |
| 50% BP | ° C. | 369 | ASTM D7169 |
| 60% BP | ° C. | 432 | ASTM D7169 |
| 70% BP | ° C. | 503 | ASTM D7169 |
| 80% BP | ° C. | 592 | ASTM D7169 |
| 90% BP | ° C. | >720 | ASTM D7169 |
| 95% BP | ° C. | >720 | ASTM D7169 |
| End Boiling Point (EBP) | ° C. | >720 | ASTM D7169 |
| BP range C5-180° C. | wt. % | 18.0 | ASTM D7169 |
| BP range 180° C.-350° C. | wt. % | 28.8 | ASTM D7169 |
| BP range 350° C.-540° C. | wt. % | 27.4 | ASTM D7169 |
| BP range >540° C. | wt. % | 25.8 | ASTM D7169 |

Weight percentages in Table 1 are based on the total weight of the crude oil.

When the hydrocarbon feed 12 comprises a crude oil, the crude oil may be a whole crude or may be a crude oil that has undergone at some processing, such as desalting, solids separation, scrubbing. For example, the hydrocarbon feed 12 may be a de-salted crude oil that has been subjected to a de-salting process. In embodiments, the hydrocarbon feed 12 may include a crude oil that has not undergone pretreatment, separation (such as distillation), or other operation that changes the hydrocarbon composition of the crude oil prior to introducing the crude oil to the system 100.

Referring again to FIG. 1, the hydrocarbon feed 12 may be fluidly coupled to the distillation system, such as to the ADU 10, so that the hydrocarbon feed 12 may be introduced to the distillation system. The distillation system may include one or more distillation units or other separation units that, in combination, may separate the hydrocarbon feed 12 into a plurality of streams, such as but not limited to one or more of a light gas stream 13, a light naphtha stream 14, a whole naphtha stream 15, a heavy naphtha stream 16, a kerosene stream 17, a gas oil stream 18, a residue 19, or combinations of these.

Still referring to FIG. 1, the distillation system may include the ADU 10. The hydrocarbon feed 12 may be in fluid communication with an inlet of the ADU 10 so that the hydrocarbon feed 12 can be directly introduced to the ADU 10. The ADU 10 may operate to separate the hydrocarbon feed 12 into at least the light gas stream 13, the plurality of distillate fractions 14, 15, 16, 17, 18 and the atmospheric residue 19. The plurality of distillate fractions 14, 15, 16, 17, 18 may include the light naphtha stream 14, the whole naphtha stream 15, the heavy naphtha stream 16, the kerosene stream 17, and the gas oil stream 18. In embodiments, the ADU 10 may separate the hydrocarbon feed 12 into an ADU tops stream, an ADU middle stream, and an ADU bottoms stream, where the ADU tops stream comprises the light gas stream 13, the ADU middle stream comprises one or more of the light naphtha stream 14, the whole naphtha stream 15, the heavy naphtha stream 16, the kerosene stream 17, the gas oil stream 18, or combinations of these, and the ADU bottoms comprises the atmospheric residue 19. The ADU 10 may include a single fractionation column or may include a plurality of atmospheric distillation units, which may be operated in series or in parallel to separate the hydrocarbon feed 12 into the various streams. As shown in FIG. 5, the distillation system may further include the VDU 50 downstream of the ADU 10. The VDU 50 will be described in further detail in relation to FIG. 5.

The light naphtha stream 14 may include constituents of the hydrocarbon feed 12 having an atmospheric boiling point temperature of from 36° C. to 85° C. The light naphtha stream 14 may include at least 90%, at least 95%, at least 98%, or at least 99% by weight of the constituents of the hydrocarbon feed 12 having an atmospheric boiling point temperature of from 36 degrees Celsius (° C.) to 85° C. The whole naphtha stream 15 may include at constituents of the hydrocarbon feed 12 having an atmospheric boiling point temperature of from 85° C. to 204° C., from 85° C. to 150° C., or from 150° C. to 204° C. The heavy naphtha stream 16 may include constituents of the hydrocarbon feed 12 having an atmospheric boiling point temperature of from 85° C. to 204° C., from 85° C. to 150° C., or from 150° C. to 204° C. This boiling point of heavy naphtha may be sent to kerosene cut in the ADU 10. The kerosene stream 17 may include constituents of the hydrocarbon feed 12 having an atmospheric boiling point temperature of from 150° C. to 250° C. or from 204° C. to 250° C. In embodiments, the kerosene stream 17 may include at least 90%, at least 95%, at least 98%, or at least 99% of the constituents of the hydrocarbon feed 12 having an atmospheric boiling point temperature of between 204° C. to 250° C. The gas oil stream 18 may include constituents of the hydrocarbon feed 12 having an atmospheric boiling point temperature of from 250° C. to 370° C. The gas oil stream 18 may include at least 90%, at least 95%, at least 98%, or at least 99% of the constituents of the hydrocarbon feed 12 having an atmospheric boiling point temperature of from 250° C. to 370° C. The atmospheric residue 19 may include the constituents of the hydrocarbon feed 12 having an atmospheric boiling point temperature of greater than or equal to 370° C. The atmospheric residue 19 may include at least 90%, at least 95%, at least 98%, or at least 99% of the constituents of the hydrocarbon feed 12 having an atmospheric boiling point temperature of greater than or equal to 370° C. The light gas stream 13 may include at least 90%, at least 95%, at least 98%, or even at least 99% of the constituents of the hydrocarbon feed 12 having an atmospheric boiling point temperature of less than or equal to 36° C.

Referring to FIGS. 1 and 2, the system 100 may further include the steam catalytic cracking system 20. The steam catalytic cracking system 20 may be disposed downstream of the distillation system, such as the ADU 10, the VDU 50 (FIG. 5), or both. The steam catalytic cracking system 20 may include at least one steam catalytic cracking reactor 200 that may be a fixed bed reactor. The steam catalytic cracking reactor 200 may operate to contact a distillate feed 110, which may include one or more of the distillate fractions 14, 15, 16, 17, 18, with steam in the presence of a nano-zeolite cracking catalyst to produce a steam cracking effluent comprising olefins.

Referring to FIG. 2, a simplified schematic illustration of one particular embodiment of the steam catalytic cracking system 20 is graphically depicted. It should be understood that other configurations of the steam catalytic cracking system may be suitable for incorporation into the system 100 for converting hydrocarbon feeds to olefins. Referring again to FIG. 2, the steam catalytic cracking system 20 may include one or a plurality of steam catalytic cracking reactors 200. The steam catalytic cracking reactor 200 may be a fixed bed catalytic cracking reactor that includes a cracking catalyst 202 disposed within a steam cracking catalyst zone 204. The steam catalytic cracking reactor 200 may include a porous packing material 208, such as silica carbide packing, upstream of the steam cracking catalyst zone 204. The porous packing material 208 may ensure sufficient heat transfer to the distillate feed 110 and steam prior to conducting the steam catalytic cracking reaction in the steam cracking catalyst zone 204.

The cracking catalyst may be a nano-zeolite cracking catalyst comprising nano-zeolite particles. A variety of nano-zeolites may be suitable for the steam catalytic cracking reactions in the steam catalytic cracking reactor 200. The nano-zeolite cracking catalyst may include a structured zeolite, such as an MFI or BEA structured zeolite, for example. In embodiments, the nano-zeolite cracking catalyst may comprise nano ZSM-5 zeolite, nano BEA zeolite, or both. In embodiments, the nano-zeolite cracking catalyst may include a combination of nano ZSM-5 zeolite and nano BEA zeolite. The nano-zeolites, such as nano-ZSM-5, nano Beta zeolite, or both may be in hydrogen form. In hydrogen form, the Brønsted acid sites in the zeolite, also known as bridging O_{H}—H groups, may form hydrogen bonds with other framework oxygen atoms in the zeolite framework.

The nano ZSM-5 zeolite, the nano Beta zeolite, or both may have a molar ratio of silica to alumina to provide sufficient acidity to the nano-zeolite cracking catalyst to conduct the steam catalytic cracking reactions. The nano-ZSM-5 zeolite, nano Beta zeolite, or both, may have a molar ratio of silica to alumina of from 10 to 200, from 15 to 200, from 20 to 200, from 10 to 150, from 15 to 150, or from 20 to 150. The nano-ZSM-5 zeolite, nano Beta zeolite, or both combined, may have total acidity in the range of 0.2 to 2.5 mmol/g, 0.3 to 2.5 mmol/g, 0.4 to 2.5 mmol/g, 0.5 to 2.5 mmol/g, 0.2 to 2.0 mmol/g, 0.3 to 2.0 mmol/g, 0.4 to 2.0 mmol/g, or 0.5 to 2.0 mmol/g. The nano-ZSM-5 zeolite, nano Beta zeolite, or both combined, may contain Brønsted acid sites in the range of 0.1 to 1.0 mmol/g, 0.2 to 1.0 mmol/g, 0.3 to 1.0 mmol/g, 0.1 to 0.9 mmol/g, 0.2 to 0.9 mmol/g, or 0.3 to 0.9 mmol/g. The concentration of Brønsted acid sites may be determined by Pyridine Fourier-transform infrared spectroscopy (FTIR). Pyridine molecule was used as a probe molecule and introduced to the cell to saturate the sample and was evacuated at 150° C. The obtained peaks at approximately 1540 and 1450 cm⁻¹ represented Brønsted and Lewis acid sites respectively. The nano-ZSM-5 zeolite, nano Beta zeolite, or both, may have an average crystal size of from 50 nanometer (nm) to 600 nm, from 60 nm to 600 nm, from 70 nm to 600 nm, from 80 nm to 600 nm, from 50 nm to 580 nm, or from 50 nm to 550 nm. The average crystal size is determined by scanning electron microscopy (SEM) according to known methods.

The nano-zeolite cracking catalyst may also include an alumina binder, which may be used to consolidate the nanoparticles of nano ZSM-5 zeolite, nano Beta zeolite, or both to form the nano-zeolite cracking catalyst. The nano-zeolite cracking catalyst may be prepared by combining the nano ZSM-5 zeolite, the nano Beta zeolite, or both with the aluminum binder and extruding the nano-zeolite cracking catalyst to form pellets or other catalyst shapes. The nano-zeolite cracking catalyst may include from 10 weight percent (wt. %) to 80 wt. %, from 10 wt. % to 75 wt. %, from 10 wt. % to 70 wt. %, from 15 wt. % to 80 wt. %, from 15 wt. % to 75 wt. %, or from 15 wt. % to 70 wt. % alumina binder based on the total weight of the nano-zeolite cracking catalyst. The nano-zeolite cracking catalyst may have a mesoporous to microporous volume ratio in the range of from 0.5 to 1.5, from 0.6 to 1.5, from 0.7 to 1.5, from 0.5 to 1.0, from 0.6 to 1.0, or from 0.7 to 1.0.

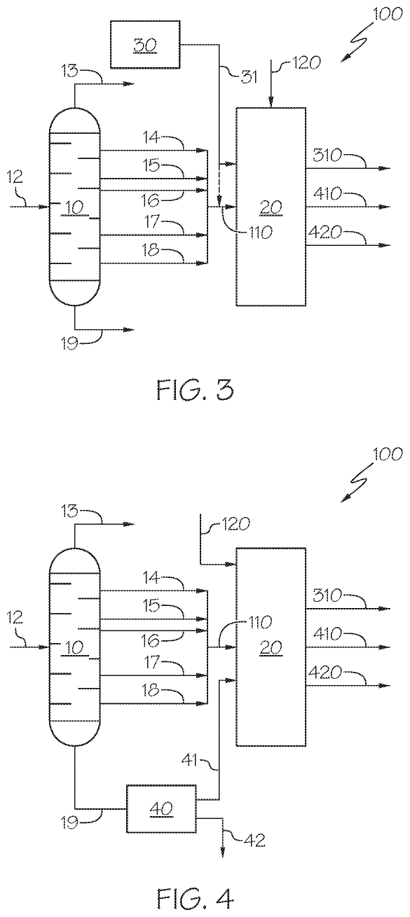

Referring again to FIG. 2, the distillate feed 110 may be introduced to the steam catalytic cracking reactor 200. The distillate feed 110 may include one or a plurality of the light naphtha stream 14, the whole naphtha stream 15, the heavy naphtha stream 16, the kerosene stream 17, the gas oil stream 18, or combinations of these from FIG. 1. The distillate feed 110 may also include a gas condensate as will be further described in relation to FIG. 3. The distillate feed 110 may also include a light vacuum gas oil, a heavy vacuum gas oil, a deasphalted oil, or combinations of these, produced from vacuum distillation of the residue 19, as will be further described in relation to FIGS. 4-6.

The distillate feed 110 may be heated to a temperature of from 35 degrees Celsius (° C.) to 150° C. and then introduced to a feed pump 130. In embodiments, the distillation feed 110 may be heated from 40° C. to 150° C., from 45° C. to 150° C., from 50° C. to 150° C., from 35° C. to 145° C., from 40° C. to 145° C., from 45° C. to 145° C., from 35° C. to 140° C., from 40° C. to 140° C., or from 45° C. to 140° C. The flowrate of the feed pump 130 may be adjusted so that the distillate feed 110 is injected into the steam catalytic cracking reactor 200 at a gas hourly space velocity of greater than or equal to 0.1 per hour (h⁻¹) or greater than or equal to 0.25 h⁻¹. The distillate feed 110 may be injected into the steam catalytic cracking reactor 200 at a gas hourly space velocity of less than or equal to 50 h⁻¹, less than or equal to 25 h⁻¹, less than or equal to 20 h⁻¹, less than or equal to 14 h⁻¹, less than or equal to 9 h⁻¹, or less than or equal to 5 h⁻¹. The distillate feed 110 may be injected into the steam catalytic cracking reactor 200 at a gas hourly space velocity of from 0.1 per hour (h⁻¹) to 50 h⁻¹, from 0.1 h⁻¹ to 25 h⁻¹, from 0.1 h⁻¹ to 20 h⁻¹, from 0.1 h⁻¹ to 14 h⁻¹, from 0.1 h⁻¹ to 9 h⁻¹, from 0.1 h⁻¹ to 5 h⁻¹, from 0.1 h⁻¹ to 4 h⁻¹, from 0.25 h⁻¹ to 50 h⁻¹, from 0.25 h⁻¹ to 25 h⁻¹, from 0.25 h⁻¹ to 20 h⁻¹, from 0.25 h⁻¹ to 14 h⁻¹, from 0.25 h⁻¹ to 9 h⁻¹, from 0.25 h⁻¹ to 5 h⁻¹, from 0.25 h⁻¹ to 4 h⁻¹, from 1 h⁻¹ to 50 h⁻¹, from 1 h⁻¹ to 25 h⁻¹, from 1 h⁻¹ to 20 h⁻¹, from 1 h⁻¹ to 14 h⁻¹, from 1 h⁻¹ to 9 h⁻¹, or from 1 h⁻¹ to 5 h⁻¹ via the preheated line 140. The distillate feed 110 may be further pre-heated in preheated line 140 to a temperature between 100° C. to 250° C. before injecting the distillate feed 110 into the steam catalytic cracking reactor 200.

Water 120 may be injected to the steam catalytic cracking reactor 200 through line 160 via the water feed pump 150. The water line 160 may be pre-heated at to a temperature of from 50° C. to 175° C., from 50° C. to 150° C., from 60° C. to 175° C., or from 60° C. to 170° C. The water 120 may be converted to steam in water line 160 or upon contacting with the distillate feed 110 in the steam catalytic cracking reactor 200. The flowrate of the water feed pump 150 may be adjusted to deliver water 120 (liquid, steam, or both) to the steam catalytic cracking reactor 200 at a gas hourly space velocity of greater than or equal to 0.1 h⁻¹, greater than or equal to 0.5 h⁻¹, greater than or equal to 1 h⁻¹, greater than or equal to 5 h⁻¹, greater than or equal to 6 h⁻¹, greater than or equal to 10 h⁻¹, or even greater than or equal to 15 h⁻¹. The water 120 may be introduced to the steam catalytic cracking reactor 200 at a gas hourly space velocity of less than or equal to 100 h⁻¹, less than or equal to 75 h⁻¹, less than or equal to 50 h⁻¹, less than or equal to 30 h⁻¹, or less than or equal to 20 h⁻¹. The water 120 may be introduced to the steam catalytic cracking reactor at a gas hourly space velocity of from 0.1 h⁻¹ to 100 h⁻¹, from 0.1 h⁻¹ to 75 h⁻¹, from 0.1 h⁻¹ to 50 h⁻¹, from 0.1 h⁻¹ to 30 h⁻¹, from 0.1 h⁻¹ to 20 h⁻¹, from 1 h⁻¹ to 100 h⁻¹, from 1 h⁻¹ to 75 h⁻¹, from 1 h⁻¹ to 50 h⁻¹, from 1 h⁻¹ to 30 h⁻¹, from 1 h⁻¹ to 20 h⁻¹, from 5 h⁻¹ to 100 h⁻¹, from 5 h⁻¹ to 75 h⁻¹, from 5 h⁻¹ to 50 h⁻¹, from 5 h⁻¹ to 30 h⁻¹, from 5 h⁻¹ to 20 h⁻¹, from 6 h⁻¹ to 100 h⁻¹, from 6 h⁻¹ to 75 h⁻¹, from 6 h⁻¹ to 50 h⁻¹, from 6 h⁻¹ to 30 h⁻¹, from 6 h⁻¹ to 20 h⁻¹, from 10 h⁻¹ to 100 h⁻¹, from 10 h⁻¹ to 75 h⁻¹, from 10 h⁻¹ to 50 h⁻¹, from 10 h⁻¹ to 30 h⁻¹, from 10 h⁻¹ to 20 h⁻¹, from 15 h⁻¹ to 100 h⁻¹, from 15 h⁻¹ to 75 h⁻¹, from 15 h⁻¹ to 50 h⁻¹, from 15 h⁻¹ to 30 h⁻¹, or from 15 h⁻¹ to 20 h⁻¹ via water line 160.

The steam from injection of the water 120 may reduce the hydrocarbon partial pressure, which may have the dual effects of increasing yields of light olefins (e.g., ethylene, propylene and butylene) as well as reducing coke formation. Light olefins like propylene and butylene are mainly generated from catalytic cracking reactions following the carbonium ion mechanism, and as these are intermediate products, they can undergo secondary reactions such as hydrogen transfer and aromatization (leading to coke formation). The steam may increase the yield of light olefins by suppressing these secondary bi-molecular reactions, and reduce the concentration of reactants and products, which favor selectivity towards light olefins. The steam may also suppresses secondary reactions that are responsible for coke formation on catalyst surface, which is good for catalysts to maintain high average activation. These factors may show that a large steam-to-oil weight ratio may be beneficial to the production of light olefins.

The gas hourly space velocity of water 120 introduced to the steam catalytic cracking reactor 200 may be greater than the gas hourly space velocity of the distillate feed 110 passed to the steam catalytic cracking reactor 200. A ratio of the flowrate (gas hourly space velocity) of steam or water 120 to the flowrate (gas hourly space velocity) of distillate feed 110 to the steam catalytic cracking reactor 200 may be from 2 to 6, from 2 to 5.5, from 2 to 5, from 3 to 6, from 3 to 5.5, or from 3 to 5 to improve the steam catalytic cracking process in the presence of the nano-zeolite cracking catalyst.

Referring again to FIG. 2, the steam catalytic cracking reactor 200 may be operable to contact the distillate feed 110 with steam (from water 120) in the presence of the nano-zeolite cracking catalyst under reaction conditions sufficient cause at least a portion of the hydrocarbons from the distillate feed 110 to undergo one or more cracking reactions to produce a steam catalytic cracking effluent 230 comprising one or a plurality of olefins. The olefins may include ethylene, propylene, butenes, or combinations of these. The steam catalytic cracking reactor 200 may be operated at a temperature of greater than or equal to 525° C., greater than or equal to 550° C., or even greater than or equal to 575° C. The steam catalytic cracking reactor 200 may be operated at a temperature of less than or equal to 750° C., less than or equal to 675° C., less than or equal to 650° C., or even less than or equal to 625° C. The steam catalytic cracking reactor 200 may be operated at a temperature of from 525° C. to 750° C., from 525° C. to 675° C., from 525° C. to 650° C., from 525° C. to 625° C., from 550° C. to 675° C., from 550° C. to 650° C., from 550° C. to 625° C., from 575° C. to 675° C., from 575° C. to 650° C., or from 575° C. to 625° C. The process may operate at atmospheric pressure (approximately from 1 to 2 bar).

The steam catalytic cracking reactor 200 may be operated in a semi-continuous manner. For example, during a conversion cycle, the steam catalytic cracking reactor 200 may be operated with the distillate feed 110 and water 120 flowing to the steam catalytic cracking reactor 200 for a period of time, at which point the catalyst may be regenerated. Each conversion cycle of the steam catalytic cracking reactor 200 may be from 2 to 24 hours, from 2 to 20 hours, from 2 to 16 hours, from 2 to 12 hours, from 2 to 10 hours, from 2 to 8 hours, from 4 to 24 hours, from 4 to 20 hours, from 4 to 16 hours, from 4 to 12 hours, from 4 to 10 hours, from or 4 to 8 hours before switching off the feed pump 130 and the water pump 150. At the end of the conversion cycle, the flow of distillate feed 110 and water 120 may be stopped and the nano-zeolite cracking catalyst may be regenerated during a regeneration cycle. In embodiments, the steam catalytic cracking system 20 may include a plurality of steam catalytic cracking reactors 200, which can be operated in parallel or in series. With a plurality of steam catalytic cracking reactors 200 operating in parallel, one or more of the steam catalytic cracking reactors 200 can continue in a conversion cycle while one or more of the other steam catalytic cracking reactors 200 are taken off-line for regeneration of the nano-zeolite cracking catalyst, thus maintaining continuous operation of the steam catalytic cracking system 20.

Referring again to FIG. 2, during a regeneration cycle, the steam catalytic cracking reactor 200 may be operated to regenerate the nano-zeolite cracking catalyst. The nano-zeolite cracking catalyst may be regenerated to remove coke deposits accumulated during the conversion cycle. To regenerate the nano-zeolite cracking catalyst, hydrocarbon gas and liquid products produced by the steam catalytic cracking process may be evacuated from the steam catalytic cracking reactor 200. Nitrogen gas may be introduced to the steam catalytic cracking reactor 200 through gas line 170 to evacuate the hydrocarbon gas and liquid products from the fixed bed steam catalytic cracking reactor 200. Nitrogen may be introduced to the steam catalytic cracking reactor 200 at gas hourly space velocity of from 10 per hour (h⁻¹) to 100 h⁻¹.

Following evacuation of the hydrocarbon gases and liquids, air may be introduced to the steam catalytic cracking reactor 200 through gas line 170 at a gas hourly space velocity of from 10 h-1 to 100 h⁻¹. The air may be passed out of the steam catalytic cracking reactor 200 through line 240. While passing air through the nano-zeolite cracking catalyst in the steam catalytic cracking reactor 200, the temperature of the steam catalytic cracking reactor 200 may be increased from the reaction temperature to a regeneration temperature of from 650° C. to 750° C. for a period of from 3 hours to 5 hours. The gas produced by air regeneration of nano-zeolite cracking catalyst may be passed out of the steam catalytic cracking reactor 200 through line 240 and may be analyzed by an in-line gas analyzer connected via line 240 to detect the presence or concentration of carbon dioxide produced through decoking of the nano-zeolite cracking catalyst. Once the carbon dioxide concentration in the gases passing out of the steam catalytic cracking reactor 200 are reduced to less than 0.05% to 0.1% by weight, as determined by the in-line gas analyzer, the temperature of the steam catalytic cracking reactor 20 temperature may be decreased from the regeneration temperature back to the reaction temperature. The air flow through line 170 may be stopped. Nitrogen gas may be passed through the nano-zeolite cracking catalyst for 15 to 30 minutes. Nitrogen gas may be stopped by closing the line 170. After closing the line 170, the flow of the distillate feed 110 and water 120 may be resumed to begin another conversion cycle of steam catalytic cracking reactor 200.

Referring again to FIG. 2, the steam catalytic cracking effluent 230 may pass out of the steam catalytic cracking reactor 200. The steam catalytic cracking effluent 230 may include one or more products and intermediates, such as but not limited to light hydrocarbon gases, olefins, aromatic compounds, pyrolysis oil, or combinations of these. Olefins in the steam catalytic cracking effluent 230 may include ethylene, propylene, butenes, or combinations of these.

The steam catalytic cracking system 20 may further include a steam catalytic cracking effluent separation system 250 disposed downstream of the steam catalytic cracking reactors 200. When the steam catalytic cracking system 20 includes a plurality of steam catalytic cracking reactors 200, the steam catalytic cracking effluents 230 from each of the steam catalytic cracking reactors 200 may be passed to a single shared steam catalytic cracking effluent separation system 250. In embodiments, each steam catalytic cracking reactor 200 may have a dedicated steam catalytic cracking effluent separation system 250. The steam catalytic cracking effluent 230 may be passed from the steam catalytic cracking reactor 200 directly to the steam catalytic cracking effluent separation system 250. The steam catalytic cracking effluent separation system 250 may separate the steam catalytic cracking effluent 230 into one or more than one cracking product effluents, which may be liquid or gaseous product effluents.

Referring again to FIG. 2, the steam catalytic cracking effluent separation system 250 may include one or a plurality of separation units. In embodiments, the steam catalytic cracking effluent separation system 250 may include the gas-liquid separation unit 300 and a centrifuge unit 400 downstream of the gas-liquid separation unit 300. The gas-liquid separation unit 300 may operate to separate the steam catalytic cracking effluent 230 into a gaseous effluent 310 and a liquid effluent 320. The gas-liquid separation unit 300 may operate to reduce the temperature of the steam catalytic cracking effluent 230 to condense constituents of the steam catalytic cracking effluent 230 having greater than or equal to 5 carbon atoms. The gas-liquid separation unit 300 may operate at a temperature of from 10° C. to 15° C. to ensure that normal pentane and constituents with boiling point temperatures greater than normal pentane are condensed into the liquid effluent 320. The liquid effluent 320 may include light distillation fractions such as naphtha, kerosene, gas oil, vacuum gas oil; unconverted feedstock; water; or combinations of these. The liquid effluent 320 may include at least 95%, at least 98%, at least 99%, or even at least 99.5% of the hydrocarbon constituents of the steam catalytic cracking effluent 230 having greater than or equal to 5 carbon atoms. The liquid effluent 320 may include at least 95%, at least 98%, at least 99%, or even at least 99.5% of the water from of the steam catalytic cracking effluent 230.

The gaseous effluent 310 may include olefins, such as ethylene, propylene, butenes, or combinations of these; light hydrocarbon gases, such as methane, ethane, propane, n-butane, i-butane, or combinations of these; other gases, such as but not limited to hydrogen; or combinations of these. The gaseous effluent 310 may include the C₂-C₄ olefin products, such as but not limited to, ethylene, propylene, butenes (1-butene, cis-2-butene, trans-2-butene, isobutene, or combinations of these), or combinations of these, produced in the steam catalytic cracking reactor 200. The gaseous effluent 310 may include at least 90%, at least 95%, at least 98%, at least 99%, or at least 99.5% of the C₂-C₄ olefins from the steam catalytic cracking effluent 230. The gaseous effluent 310 may be passed to a downstream gas separation system for further separation of the gaseous effluent 310 into various product streams, such as but not limited to one or more olefin product streams.

The liquid effluent 320, which includes the water and hydrocarbon having greater than 5 carbon atoms, may be passed to the in-line centrifuge unit 400. The in-line centrifuge unit 400 may operate to separate the liquid effluent 320 into a liquid hydrocarbon effluent 410 and an aqueous effluent 420. The in-line centrifuge unit 400 may be operated at a rotational speed of from 2500 rpm to 5000 rpm, from 2500 rpm to 4500 rpm, from 2500 rpm to 4000 rpm, from 3000 rpm to 5000 rpm, from 3000 rpm to 4500 rpm, or from 3000 rpm to 4000 rpm to separate the hydrocarbon phase from the aqueous phase.

The liquid hydrocarbon effluent 410 may include hydrocarbons from the steam catalytic cracking effluent 230 having greater than or equal to 5 carbon atoms. These hydrocarbons may include naphtha, kerosene, diesel, vacuum gas oil (VGO), or combinations of these. The liquid hydrocarbon effluent 410 may include at 90%, at least 95%, at least 98%, at least 99%, or even at least 99.5% of the hydrocarbon constituents from the liquid effluent 320. The liquid hydrocarbon effluent 410 may be passed to a downstream treatment processes for further conversion or separation. At least a portion of the liquid hydrocarbon effluent 410 may be passed back to the steam catalytic cracking reactor 200 for further conversion to olefins. The aqueous effluent 420 may include water and water soluble constituents from the liquid effluent 320. The aqueous effluent 420 may include some dissolved hydrocarbons soluble in the aqueous phase of the liquid effluent 320. The aqueous effluent 420 may include at least 95%, at least 98%, at least 99%, or even at least 99.5% of the water from the liquid effluent 320. The aqueous effluent 420 may be passed to one or more downstream processes for further treatment. In embodiments, at least a portion of the aqueous effluent 420 may be passed back to the steam catalytic cracking reactor 200 as at least a portion of the water 120 introduced to the steam catalytic cracking reactor 200.

Referring again to FIG. 1, the system 100 for converting a hydrocarbon feed 12 to olefins may include the ADU 10 and the steam catalytic cracking system 20 downstream of the ADU 10. The hydrocarbon feed 12 may be introduced to the ADU 10. As previously discussed, the ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. The ADU 10 may be in fluid communication with the steam catalytic cracking system 20 to pass the light naphtha stream 14, the whole naphtha stream 15, the heavy naphtha stream 16, the kerosene stream 17, the gas oil stream 18, or combinations of these to the steam catalytic cracking system 20. The light naphtha stream 14, the whole naphtha stream 15, the heavy naphtha stream 16, the kerosene stream 17, the gas oil stream 18, or combinations of these may be introduced to the steam catalytic cracking system 20 as the distillate feed 110. In embodiments, the distillate feed 110 may include all of the light naphtha stream 14, the whole naphtha stream 15, the heavy naphtha stream 16, the kerosene stream 17, and the gas oil stream 18. In embodiments, the distillate feed 110 may include constituents of the hydrocarbon feed 12 having boiling point temperatures of from 36° C. to 370° C. The light gas stream 13 may be passed out of the system 100. In embodiments, the atmospheric residue stream 19 may be passed out of the system 100.

As previously discussed, the steam catalytic cracking system 20 may contact the distillate feed 110 with steam in the presence of the nano-zeolite cracking catalyst to steam catalytic crack at least a portion of the hydrocarbons in the distillate feed 110 to produce olefins, such as but not limited to ethylene, propylene, butenes, or combinations of these. The system 100 may achieve an olefin yield in mol. % of from 30% to 45% olefins per barrel of crude oil. The olefins may be passed out of the steam catalytic cracking system 20 in a gaseous effluent 310. The gaseous effluent 310 may be passed to one or more downstream processes for further separation into one or more product streams. The steam catalytic cracking system 20 may also produce the liquid hydrocarbon effluent 410 and the aqueous effluent 420.

Referring now to FIG. 3, the system 100 may further include introducing a gas condensate 31 to the steam catalytic cracking system 20 in addition to the distillate feed 110. Some refineries may have limited topping capacity for producing distillate fractions. In these refineries, gas condensates may be combined with the distillate fractions 14, 15, 16, 17, 18, to produce the distillate feed 110. The system 100 may include a gas condensate feed unit 30 that may feed the gas condensate 31 to the steam catalytic cracking system 20. The gas condensate feed unit 30 may be an intermediate storage vessel containing gas condensate 31, a gas plant operating to separate gas condensate 31 from raw natural gas produced from a subterranean formation, or other system capable of feeding a gas condensate 31 to the steam catalytic cracking system 20. The gas condensate 31 may be passed directly from the condensate feed unit 30 to the steam catalytic cracking system 20 or may be combined with the distillate feed 110 upstream of the steam catalytic cracking system 20.

The gas condensate 31 may be liquid hydrocarbon stream. The gas condensate 31 may comprise distillation fractions, such as naphtha, kerosene, gas oil, or combinations thereof. In embodiments, the gas condensate 31 may be a gas condensate produced from the Khuff geological formation. When the gas condensate 31 comprises a Khuff gas condensate, the gas condensate 31 may include about 3.6 wt. % C₄ fraction, 15.5 wt. % light naphtha, 28.3 wt. % middle naphtha, 15 wt. % heavy naphtha fraction, 15.7 wt. % kerosene, and 21.9 wt. % gas oil. The gas condensate 31 may have an API gravity of from 50 degrees to 60 degrees, or from 50 degrees to 58 degrees. The gas condensate 31 may have sulfur content of from 0.01 to 0.2 wt. %, from 0.02 to 0.2 wt. %, or from 0.01 to 0.1 wt. %. When the gas condensate 31 comprises a Khuff gas condensate, the gas condensate 31 may have an API gravity of 53.9 degrees and sulfur content of 0.04 wt. %.

Referring again to FIG. 3, the total feed to the steam catalytic cracking system 20 may include from 5 wt. % to 50 wt. % gas condensate 31 based on the total flow rate of hydrocarbons (gas condensate 31 and the distillate feed 110) passed to the steam catalytic cracking system 20. In embodiments, the total hydrocarbon feed to the steam catalytic cracking system 20 may include from 10 wt. % to 50 wt. %, from 15 wt. % to 50 wt. %, from 20 wt. % to 50 wt. %, from 5 wt. % to 45 wt. %, from 5 wt. % to 40 wt. %, from 10 wt. % to 45 wt. %, from 10 wt. % to 40 wt. %, from 15 wt. % to 45 wt. %, or from 15 wt. % to 40 wt. % gas condensate 31 based on the total flow rate of gas condensate 31 and distillate feed 110 passed to the steam catalytic cracking system 20.

Referring again to FIG. 3, in operation of the system 100 for converting hydrocarbon feed 12 to olefins, the hydrocarbon feed 12 may be introduced to the ADU 10. The ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. One or more of the light naphtha stream 14, the whole naphtha stream 15, the heavy naphtha stream 16, the kerosene stream 17, the gas oil stream 18, or combinations of these may be combined to form the distillate feed 110. The gas condensate 31 may be passed directly to the steam catalytic cracking system 20 or may be combined with the distillate feed 110 upstream of the steam catalytic cracking system 20. The steam catalytic cracking system 20 may contact the distillate feed 110 and gas condensate 31 with steam in the presence of the nano-zeolite cracking catalyst to steam catalytic crack at least a portion of the hydrocarbons in the distillate feed 110 and gas condensate 31 to produce olefins, such as but not limited to ethylene, propylene, butenes, or combinations of these. The system 100 depicted in FIG. 3 may achieve an olefin yield of from 30 mol. % to 45 mol. % olefins from the distillate feed 110 and gas condensate 31 fed to the steam catalytic cracking system 20. The olefins may be passed out of the steam catalytic cracking system 20 in the gaseous effluent 310. The gaseous effluent 310 may be passed to one or more downstream processes for further separation into one or more product streams. The steam catalytic cracking system 20 may also produce the liquid hydrocarbon effluent 410 and the aqueous effluent 420.

Referring now to FIG. 4, the system 100 may further include a solvent deasphalting (SDA) unit 40 downstream of the distillation system, such as downstream of the ADU 10. The SDA unit 40 may be operable to remove asphaltene compounds from the atmospheric residue 19 to produce a deasphalted oil 41 that may be passed to the steam catalytic cracking system 20. Passing the deasphalted oil 41 to the steam catalytic cracking system 20 may further increase the conversion of the hydrocarbon feed 12 to olefins in the system 100. The SDA unit 40 may be disposed upstream of the steam catalytic cracking system 20. The SDA unit 40 may receive the atmospheric residue 19 from the ADU 10 and may remove asphaltene compounds from the atmospheric residue 19 to produce a deasphalted oil 41 and an SDA residue 42. The atmospheric residue 19 may include up to 20 wt. % asphaltene compounds based on the total weight of the atmospheric residue 19. The SDA unit 40 may reduce asphaltene content of atmospheric residue 19 from 20 wt. % to less than or equal to 0.0.1 wt. %, or even less than or equal to 0.01 wt. %. The deasphalted oil 41 may have less than 0.1 wt. % or even less than 0.01 wt. % asphaltene compounds. The SDA residue 42 may include at least 95%, at least 98%, at least 99%, or at least 99.5% of the asphaltene compounds from the atmospheric residue 19.

Referring again to FIG. 4, the SDA unit 40 may be in fluid communication with the steam catalytic cracking system 20 to pass the deasphalted oil 41 to the steam catalytic cracking system 20. The deasphalted oil 41 may be passed directly from the SDA unit 40 to the steam catalytic cracking system 20 or may be combined with the distillate feed 110 upstream of the steam catalytic cracking system 20.

In operation of the system 100 for converting hydrocarbon feed 12 to olefins in FIG. 4, the hydrocarbon feed 12 may be introduced to the ADU 10. As previously discussed, the ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. The light naphtha stream 14, the whole naphtha stream 15, the heavy naphtha stream 16, the kerosene stream 17, the gas oil stream 18, or combinations of these may be combined to form the distillate feed 110. In embodiments, the distillate feed 110 may include the light naphtha stream 14, the whole naphtha stream 15, the heavy naphtha stream 16, the kerosene stream 17, and the gas oil stream 18. The distillate feed 110 may be passed to the steam catalytic cracking system 20. The atmospheric residue 19 may be passed to the SDA unit 40. The SDA unit 40 may remove at least a portion of the asphaltene compounds from the atmospheric residue 19 to produce the deasphalted oil 41 and the SDA residue 42. The deasphalted oil 41 may be passed from the SDA unit 40 to the steam catalytic cracking system 20. Passing the light naphtha stream 14, the whole naphtha stream 15, the heavy naphtha stream 16, the kerosene stream 17, the gas oil stream 18, and the deasphalted oil 41 to the steam catalytic cracking system 20 may result passing at least 80%, at least 85%, or even at least 90% by weight of the hydrocarbon feed 12 to the steam catalytic cracking system 20.

The steam catalytic cracking system 20 may contact the distillate feed 110 and the deasphalted oil 41 with steam in the presence of the nano-zeolite cracking catalyst to steam catalytic crack at least a portion of the hydrocarbons in the distillate feed 110 and the deasphalted oil 41 to produce olefins, such as but not limited to ethylene, propylene, butenes, or combinations of these. The system 100 depicted in FIG. 4 may achieve an olefin yield of from 45 mol. % to 55 mol. % olefins per barrel of the hydrocarbon feed introduced to the ADU 10. The olefins may be passed out of the steam catalytic cracking system 20 in the gaseous effluent 310. The gaseous effluent 310 may be passed to one or more downstream processes for further separation into one or more product streams. The steam catalytic cracking system 20 may also produce the liquid hydrocarbon effluent 410 and the aqueous effluent 420.

Referring to FIG. 5, the system 100 may further include the distillation system that includes the ADU 10 and the vacuum distillation unit (VDU) 50. The VDU 50 may be disposed downstream of the ADU 10. The atmospheric residue 19 from the ADU 10 may be passed to the VDU 50. The VDU 50 may be operable to separate the atmospheric residue 19 into at least one vacuum gas oil stream 51, 52 and a vacuum residue 53. The at least one vacuum gas oil stream may include a light vacuum gas oil stream 51, a heavy vacuum gas oil stream 52, or both. The light vacuum gas oil stream 51, the heavy vacuum gas oil stream 52, or both may be passed to the steam catalytic cracking system 20 to further increase the yield of olefins from the hydrocarbon feed 12. The VDU 50 may include a single fractionation column or may include a plurality of vacuum distillation units, which may be operated in series or in parallel to separate the atmospheric residue 19 into the light vacuum gas oil stream 51, the heavy vacuum gas oil stream 52, the vacuum residue 53, or combinations of these.

The light vacuum gas oil stream 51 may include constituents of the atmospheric residue 19 having an atmospheric boiling point temperature of from 370° C. to 454° C. The light vacuum gas oil stream 51 may include at least 90%, at least 95%, at least 98%, or at least 99% by weight of the constituents of the atmospheric residue 19 having an atmospheric boiling point temperature of from 370° C. to 454° C. The heavy vacuum gas oil stream 52 may include constituents of the atmospheric residue 19 having atmospheric boiling point temperatures of from 454° C. to 565° C. The heavy vacuum gas oil stream 52 may include at least 90%, at least 95%, at least 98%, or at least 99% of the constituents of the atmospheric residue 19 having an atmospheric boiling point temperature of from 454° C. to 565° C. The vacuum residue 53 may include the constituents of the atmospheric residue 19 having atmospheric boiling point temperatures of greater than 565° C. The vacuum residue 53 may include at least 90%, at least 95%, at least 98%, or at least 99% of the constituents of the atmospheric residue 19 having a vacuum boiling point temperature of greater than or equal to 565° C.

Referring again to FIG. 5, the VDU 50 may be in fluid communication with the steam catalytic cracking system 20 to pass the light vacuum gas oil 51, the heavy vacuum gas oil 52, or both to the steam catalytic cracking system 20. The light vacuum gas oil 51, the heavy vacuum gas oil 52, or both may be passed directly to the steam catalytic cracking system 20 or may be combined with the distillate feed 110 upstream of the steam catalytic cracking system 20. In embodiments, the vacuum residue 53 may be passed out of the system 100 for further processing or treatment.

Referring again to FIG. 5, in operation of the system 100 for converting the hydrocarbon feed 12 to olefins, the hydrocarbon feed 12 may be introduced to the ADU 10. As previously discussed, the ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. The light naphtha stream 14, the whole naphtha stream 15, the heavy naphtha stream 16, the kerosene stream 17, the gas oil stream 18, or combinations of these may be combined to form the distillate feed 110. In embodiments, the distillate feed 110 may include the light naphtha stream 14, the whole naphtha stream 15, the heavy naphtha stream 16, the kerosene stream 17, and the gas oil stream 18. The distillate feed 110 may be passed to the steam catalytic cracking system 20. The ADU 10 may be in fluid communication with the steam catalytic cracking system 20 to pass at least one of the light naphtha stream 14, the whole naphtha stream 15, the heavy naphtha stream 16, the kerosene stream 17, and the gas oil stream 18 to the steam catalytic cracking system 20.

The atmospheric residue 19 may be passed from the ADU 10 to the VDU 50. The VDU may separate the atmospheric residue 19 into the light vacuum gas oil stream 51, the heavy vacuum gas oil stream 52, the vacuum residue 53, or combinations of these. The light vacuum gas oil stream 51, the heavy vacuum gas oil stream 52, or both may be passed to the steam catalytic cracking system 20 or combined with the distillate feed 110 upstream of the steam catalytic cracking system 20. Passing the distillate feed 110, the light vacuum gas oil 51, and the heavy vacuum gas oil 52 to the steam catalytic cracking system 20 may result in passing at least 70%, at least 75%, at least 80%, or even at least 85% by weight of the hydrocarbon feed 12 to the steam catalytic cracking system 20.

The steam catalytic cracking system 20 may contact the distillate feed 110, the light vacuum gas oil 51, the heavy vacuum gas oil 52, or combinations of these with steam in the presence of the nano-zeolite cracking catalyst to steam catalytic crack at least a portion of the hydrocarbons in the distillate feed 110, the light vacuum gas oil 51, or the heavy vacuum gas oil 52 to produce olefins, such as but not limited to ethylene, propylene, butenes, or combinations of these. The system 100 may achieve an olefin yield of from 40 mol. % to 52 mol. % olefins per barrel of hydrocarbon feed 12 introduced to the ADU 10. The olefins may be passed out of the steam catalytic cracking system 20 in the gaseous effluent 310. The gaseous effluent 310 may be passed to one or more downstream processes for further separation into one or more product streams. The steam catalytic cracking system 20 may also produce the liquid hydrocarbon effluent 410 and the aqueous effluent 420.

Referring now to FIG. 6, the system 100 may include the distillation system that includes the ADU 10 and the VDU 50 downstream of the ADU 10. The system 100 may also include a vacuum residue SDA unit 60 that may be operable to remove asphaltene compounds from the vacuum residue 53 to produce a deasphalted oil 61, which may be passed to the steam catalytic cracking system 20 to further increase the yield of olefins from the hydrocarbon feed 12. The VDU 50 may be disposed downstream of the ADU 10. The atmospheric residue 19 may be passed from the ADU 10 to the VDU 50. The VDU 50 may be operable to separate the atmospheric residue 19 into the light vacuum gas oil stream 51, the heavy vacuum gas oil stream 52, the vacuum residue 53, or combinations of these. The VDU 50 may be in fluid communication with the steam catalytic cracking system 20 to pass the light vacuum gas oil stream 51, the heavy vacuum gas oil stream 52, or both directly from the VDU 50 to the steam catalytic cracking system 20.

The vacuum residue SDA unit 60 may be disposed downstream of the VDU 50. The vacuum residue SDA unit 60 may be in fluid communication with the VDU 50 to receive the vacuum residue directly from the VDU 50. The vacuum residue SDA unit 60 may be disposed upstream of the steam catalytic cracking system 20. The SDA unit 60 may be operable to remove asphaltene compounds from the vacuum residue 53 to produce a deasphalted vacuum residue 61 and an SDA residue 62. The vacuum residue 53 may include up to 20 wt. % asphaltene compounds based on the total weight of the vacuum residue 53. The vacuum residue SDA unit 60 may reduce the asphaltene content of the vacuum residue 53 from 20 wt. % to less than or equal to 0.1 wt. % or even less than or equal to 0.01 wt. % to produce a deasphalted oil 61. The deasphalted oil 61 may have less than or equal to 0.1 wt. % or even less than or equal to 0.01 wt. % asphaltene compounds based on the total weight of the deasphalted oil 61. The SDA residue 62 may include at least 95%, at least 98%, at least 99%, or at least 99.5% of the asphaltene compounds from the vacuum residue 53.

Referring again to FIG. 6, the vacuum residue SDA unit 60 may be in fluid communication with the steam catalytic cracking system 20 to pass the deasphalted oil 61 to the steam catalytic cracking system 20. The deasphalted oil 61 may be passed directly from the vacuum residue SDA unit 60 to the steam catalytic cracking system 20 or may be combined with the distillate feed 110, the light vacuum gas oil 51, the heavy vacuum gas oil 52, or combinations of these, upstream of the steam catalytic cracking system 20.

Referring to FIG. 6, in operation of the system 100 for converting hydrocarbon feed 12 to olefins, the hydrocarbon feed 12 may be introduced to the ADU 10. As previously discussed, the ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. The light naphtha stream 14, the whole naphtha stream 15, the heavy naphtha stream 16, the kerosene stream 17, the gas oil stream 18, or combinations of these may be combined to form the distillate feed 110. In embodiments, the distillate feed 110 may include the light naphtha stream 14, the whole naphtha stream 15, the heavy naphtha stream 16, the kerosene stream 17, and the gas oil stream 18. The distillate feed 110 may be passed to the steam catalytic cracking system 20.

The atmospheric residue 19 may be passed to the VDU 50. The VDU 50 may separate the atmospheric residue 19 to produce the light vacuum gas oil stream 51, the heavy vacuum gas oil stream 52, and the vacuum residue 53. The light vacuum gas oil stream 51, the heavy vacuum gas oil stream 52, or both may be passed from the VDU 50 to the steam catalytic cracking system 20. The vacuum residue 53 may be passed to the vacuum residue SDA unit 60, which may remove at least a portion of the asphaltene compounds from the vacuum residue 53 to produce a deasphalted oil 61 and an SDA residue 62. The deasphalted oil 61 may be passed to the steam catalytic cracking system 20. The SDA residue 62 may be passed out of the system 100. The deasphalted oil 61 may be combined with at least one of the light naphtha stream 14, the whole naphtha stream 15, the heavy naphtha stream 16, the kerosene stream 17, the gas oil stream 18, the light vacuum gas oil stream 51, the heavy vacuum gas oil stream 52, or combinations of these upstream of the steam catalytic cracking system 20. Passing the light naphtha stream 14, the whole naphtha stream 15, the heavy naphtha stream 16, the kerosene stream 17, the gas oil stream 18, the light vacuum gas oil stream 51, the heavy vacuum gas oil stream 52, and the deasphalted oil 61 to the steam catalytic cracking system 20 may result in passing at least 80%, at least 85%, or even at least 90% by weight of the hydrocarbon feed 12 to the steam catalytic cracking system 20.

The steam catalytic cracking system 20 may contact the distillate feed 110, the light vacuum gas oil 51, the heavy vacuum gas oil 52, the deasphalted oil 61, or combinations of these, with steam in the presence of the nano-zeolite cracking catalyst to steam catalytic crack at least a portion of the hydrocarbons in the distillate feed 110, the light vacuum gas oil 51, or the heavy vacuum gas oil 52, or deasphalted oil 61 to produce olefins, such as but not limited to ethylene, propylene, butenes, or combinations of these. The system 100 may achieve an olefin yield of from 45 mol. % to 55 mol. % olefins per barrel of hydrocarbon feed 12 introduced to the ADU 10. The olefins may be passed out of the steam catalytic cracking system 20 in the gaseous effluent 310. The gaseous effluent 310 may be passed to one or more downstream processes for further separation into one or more product streams. The steam catalytic cracking system 20 may also produce the liquid hydrocarbon effluent 410 and the aqueous effluent 420.

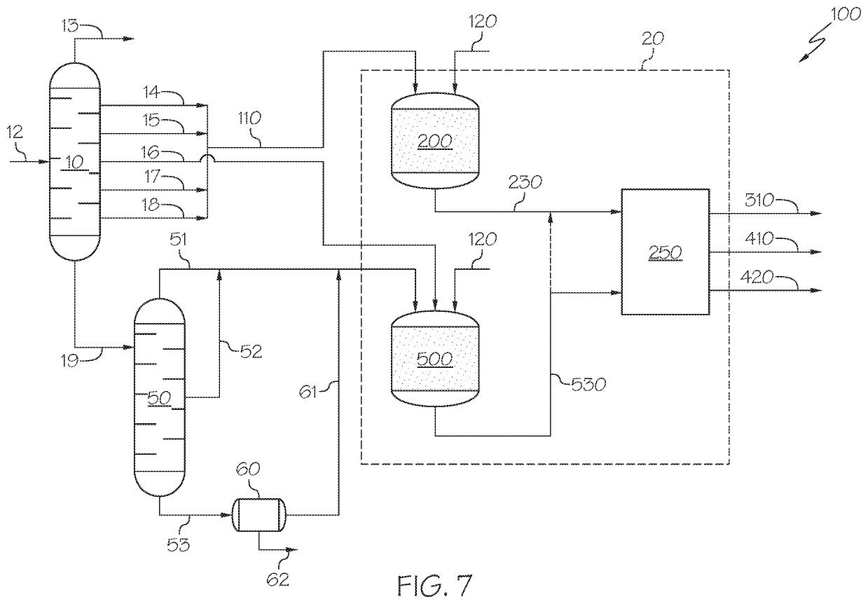

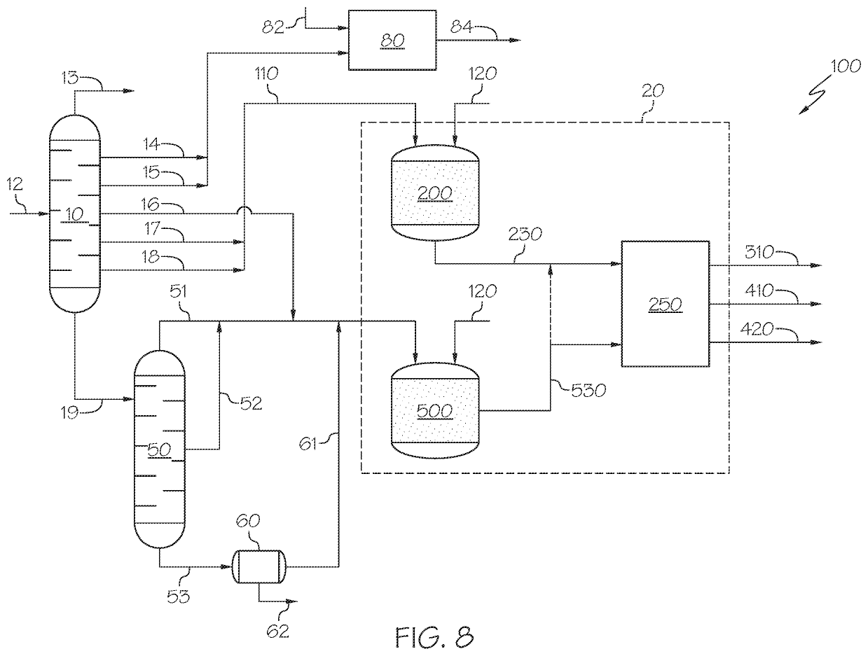

Referring now to FIG. 7, the steam catalytic cracking system 20 may include a first steam catalytic cracking reactor 200 and a second steam catalytic cracking reactor 500. The system 100 depicted in FIG. 7 may also include the ADU 10, the VDU 50 downstream of the ADU 10, and the vacuum residue SDA unit 60 downstream of the VDU 50. The ADU 10, VDU 50, and vacuum residue SDA unit 60 may have any of the features or characteristics previously described in the present disclosure for these unit operations. The second steam catalytic cracking reactor 500 may be operated in parallel with the first steam catalytic cracking reactor 200. The first steam catalytic cracking reactor 200 may be disposed downstream of the ADU 10. The second fixed bed steam catalytic cracking reactor 500 may be disposed downstream of the VDU 50. The second steam catalytic cracking reactor 500 may also be disposed downstream of the vacuum residue SDA unit 60. The first steam catalytic cracking reactor 200, the second steam catalytic cracking reactor 500, or both may include one or a plurality of fixed bed steam catalytic cracking reactors operated in parallel or in series. In embodiments, each of the first steam catalytic cracking reactor 200 and the second steam catalytic cracking reactor 500 may include a plurality of steam catalytic cracking reactors operated in parallel so that continuous operation of the steam catalytic cracking system 20 can be maintained, while also regenerating the nano zeolite cracking catalyst.

As previously discussed, the ADU 10 and the VDU 50 may separate the hydrocarbon feed 12 into the plurality of distillate fractions including one or more of the light naphtha stream 14, the whole naphtha stream 15, the heavy naphtha stream 16, the kerosene stream 17, the gas oil stream 18, the light vacuum gas oil stream 51, the heavy vacuum gas oil stream 52, or combinations of these. The first steam catalytic cracking reactor 200 may be in fluid communication with the ADU 10 to pass at least one of the distillate fractions, such as the light naphtha stream 14, the whole naphtha stream 15, the heavy naphtha stream 16, the kerosene stream 17, the gas oil stream 18, or combinations of these, to the first steam catalytic cracking reactor 200. The second steam catalytic cracking reactor 500 may be in fluid communication with the VDU 50, the vacuum residue SDA unit 60, or both to pass at least one of the light vacuum gas oil 51, the heavy vacuum gas oil 52, the deasphalted oil 61, or combinations of these to the second steam catalytic cracking reactor 500. The second steam catalytic cracking reactor 500 may also be in fluid communication with the ADU 10 to pass at least one of the distillate fractions, such as the light naphtha stream 14, the whole naphtha stream 15, the heavy naphtha stream 16, the kerosene stream 17, the gas oil stream 18, or combinations of these, to the second steam catalytic cracking reactor 500.

Referring again to FIG. 7, in operation of the system 100 for converting hydrocarbon feed 12 to olefins, the hydrocarbon feed 12 may be introduced to the ADU 10. As previously discussed, the ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. The atmospheric residue 19 may be passed to the VDU 50, which may separate the atmospheric residue 19 into the light vacuum gas oil stream 51, the heavy vacuum gas oil stream 52, and the vacuum residue 53. The vacuum residue 53 may be passed to the vacuum residue SDA unit 60, which may remove asphaltene compounds from the vacuum residue 53 to produce the deasphalted oil 61 and the SDA residue 62, as previously described in this disclosure.

Referring again to FIG. 7, the light naphtha stream 14, the whole naphtha stream 15, the heavy naphtha 16, the kerosene stream 17, the gas oil stream 18, or combinations of these may be passed to the first steam catalytic cracking reactor 200. In embodiments, the light naphtha stream 14, the whole naphtha stream 15, the kerosene stream 17, and the gas oil stream 18 may be passed to the first steam catalytic cracking reactor 200, and the heavy naphtha 16 may be passed to the second steam catalytic cracking reactor 500. At least one of the light naphtha stream 14, the whole naphtha stream 15, the heavy naphtha 16, the kerosene stream 17, the gas oil stream 18, the light vacuum gas oil stream 51, the heavy vacuum gas oil stream 52, the deasphalted oil 61, or combinations of these may be passed to the second steam catalytic cracking reactor 500. In embodiments, the heavy naphtha 16, the light vacuum gas oil stream 51, the heavy vacuum gas oil stream 52, and the deasphalted oil 61 may be passed to the second steam catalytic cracking reactor 500. The total hydrocarbons passed to the first steam catalytic cracking reactor 200 and the second steam catalytic cracking reactor 500 may be at least 80%, at least 85%, or even at least 90% of the hydrocarbon feed 12 to the ADU 10.

The first steam catalytic cracking reactor 200 may contact the light naphtha stream 14, the whole naphtha stream 15, the kerosene stream 17, the gas oil stream 18, or combinations of these with steam in the presence of the nano-zeolite cracking catalyst to steam catalytic crack at least a portion of the hydrocarbons in the light naphtha stream 14, the whole naphtha stream 15, the kerosene stream 17, and the gas oil stream 18 to produce olefins, such as but not limited to ethylene, propylene, butenes, or combinations of these. The second steam catalytic cracking reactor 500 may contact the heavy naphtha stream 16, the light vacuum gas oil stream 51, the heavy vacuum gas oil stream 52, and the deasphalted oil 61 with steam in the presence of the nano-zeolite cracking catalyst to steam catalytic crack at least a portion of the hydrocarbons in the heavy naphtha stream 16, the light vacuum gas oil stream 51, the heavy vacuum gas oil stream 52, and the deasphalted oil 61 to produce olefins, such as but not limited to ethylene, propylene, butenes, or combinations of these. The system 100 depicted in FIG. 7 with the first steam catalytic cracking reactor 200 and the second steam catalytic cracking reactor 500 may achieve an olefin yield of from 45 mol. % to 55 mol. % olefins per barrel of hydrocarbon feed 12 introduced to the ADU 10.

Referring again to FIG. 7, the first steam catalytic cracking reactor 200 and the second steam catalytic cracking reactor 500 may share a common steam catalytic cracking effluent separation system 250. A first steam catalytic cracking effluent 230 may be passed from the first steam catalytic cracking reactor 200 to the steam catalytic cracking effluent separation system 250. A second steam catalytic cracking effluent 530 may be passed from the second steam catalytic cracking reactor 500 to the steam catalytic cracking effluent separation system 250. As previously discussed, the steam catalytic cracking effluent separation system 250 may be operable to separate the effluents from the steam catalytic cracking reactors 200, 500 into the gaseous effluent 310 comprising the olefin products, the liquid hydrocarbon effluent 410, and the aqueous effluent 420. Although depicted in FIG. 7 as having a single common shared steam catalytic cracking effluent separation system 250, it is understood that each of the steam catalytic cracking reactors could have a steam catalytic cracking effluent separation system.

Referring to FIG. 8, the system 100 may further include a steam cracking unit 80. The steam cracking unit 80 may be operated in parallel to the steam catalytic cracking system 20. The system 100 in FIG. 8, may also include the ADU 10, the VDU 50, the vacuum residue SDA unit 60, and the steam catalytic cracking system 20. The arrangement and operation of the ADU 10, the VDU 50, the vacuum residue SDA unit 60, and the steam catalytic cracking system 20 may be the same as previously described in relation to FIG. 7. The steam cracking unit 80 may be in fluid communication with the ADU 10 to pass at least one of the distillate streams from the ADU 10 to the steam cracking unit 80.

The steam cracking unit 80 may operate to steam crack at least one naphtha stream 14, 15, 16 to produce a steam cracking effluent 82. The naphtha stream passed to the steam cracking unit 80 may include the light naphtha stream 14, the whole naphtha stream 15, the heavy naphtha stream 16, or combinations of these. The steam cracking unit 80 may be operable to contact the at least one of the light naphtha stream 14, the whole naphtha stream 15, the heavy naphtha stream 16, or combinations of these with steam 82 at a steam cracking temperature sufficient to cause at least a portion of the hydrocarbons in the naphtha stream 14, 15, 16 to undergo cracking reactions to produce a steam cracking effluent 84 comprising olefins.

The steam cracking unit 80 may operate at a steam cracking temperature of from 700° C. to 900° C. In embodiments, the steam cracking unit 80 may operate at a steam cracking temperature of from 700° C. to 850° C., from 700° C. to 800° C., from 725° C. to 900° C., from 725° C. to 850° C., from 725° C. to 800° C., or about 750° C. Steam 82 may be introduced to the steam cracking unit 80. The molar ratio of hydrocarbons to steam in the steam cracking unit 80 may be from 0.2 to 0.5. In embodiments, the molar ratio of naphtha stream to steam may be from 0.3 to 0.35.

The steam cracking unit 80 may include a convection zone and a pyrolysis zone. The at least one of the light naphtha stream 14, and the whole naphtha stream 15 may pass into the convection zone along with steam. In the convection zone, the at least one of the light naphtha stream 14, and the whole naphtha stream 15 may be pre-heated to a desired temperature, such as from 400° C. to 650° C. The contents of the at least one of the light naphtha stream 14, and the whole naphtha stream 15 present in the convection zone may then be passed to the pyrolysis zone where it may be steam-cracked to produce the steam cracking effluent 84. The steam cracking effluent 84 may exit the steam cracking system and be passed through a heat exchanger (not shown) where a process fluid, such as water or pyrolysis fuel oil, cools the steam cracking effluent 84. The steam cracking effluent 84 may include olefins, such as but not limited to ethylene, propylene, butenes, or combinations of these. The steam cracking effluent 84 may be passed out of the system 100 to one or more downstream operations, such as process operations for separating the steam cracking effluent 84 into one or more olefin product streams.

Referring again to FIG. 8, in operation of the system 100 for converting the hydrocarbon feed 12 to olefins, the hydrocarbon feed 12 may be introduced to the ADU 10. As previously discussed, the ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. The atmospheric residue 19 may be passed to the VDU 50, which may separate the atmospheric residue 19 into the light vacuum gas oil stream 51, the heavy vacuum gas oil stream 52, and the vacuum residue 53. The vacuum residue 53 may be passed to the vacuum residue SDA unit 60, which may remove asphaltene compounds from the vacuum residue 53 to produce the deasphalted oil 61 and the SDA residue 62, as previously described in this disclosure.

In embodiments, the kerosene stream 17 and the gas oil stream 18 may be passed from the ADU 10 to the first steam catalytic cracking reactor 200, the light naphtha stream 14 and the whole naphtha stream 15 may be passed from the ADU 10 to the steam cracking unit 80, and the heavy naphtha stream 16, the light vacuum gas oil 51, the heavy vacuum gas oil 52, the deasphalted oil 61, or combinations of these may be passed to the second steam catalytic cracking reactor 500. In embodiments, the whole naphtha stream 15 may be passed to the first catalytic steam cracking reactor 200 instead of the steam cracking unit 80. In embodiments, the heavy naphtha 16 may be passed to the first steam catalytic cracking reactor 200 or the steam cracking unit 80 instead of the second steam catalytic cracking reactor 500. Other distributions of the distillate streams to the steam cracking unit 80, the first steam catalytic cracking reactor 200, and the second steam catalytic cracking reactor 500 are contemplated. The total hydrocarbons passed to the steam cracking unit 80, the first steam catalytic cracking reactor 200, and the second steam catalytic cracking reactor 500 may be at least 80%, at least 85%, or even at least 90% of the hydrocarbon feed 12 to the ADU 10.

Referring again to FIG. 8, the first steam catalytic cracking reactor 200 may contact the kerosene stream 17 and the gas oil stream 18 with steam in the presence of the nano-zeolite cracking catalyst to steam catalytic crack at least a portion of the hydrocarbons in the kerosene stream 17 and the gas oil stream 18 to produce olefins, such as but not limited to ethylene, propylene, butenes, or combinations of these. The second steam catalytic cracking reactor 500 may contact the heavy naphtha stream 16, the light vacuum gas oil stream 51, the heavy vacuum gas oil stream 52, the deasphalted oil 61, or combinations of these with steam in the presence of the nano-zeolite cracking catalyst to steam catalytic crack at least a portion of the hydrocarbons in the heavy naphtha stream 16, the light vacuum gas oil stream 51, the heavy vacuum gas oil stream 52, the deasphalted oil 61, or combinations of these to produce olefins, such as but not limited to ethylene, propylene, butenes, or combinations of these. The first steam catalytic cracking effluent 230 and the second steam catalytic cracking effluent 530 may be passed to the steam catalytic cracking effluent separation system 250 for separation into the gaseous effluent 310, the liquid hydrocarbon effluent 410, and the aqueous effluent 420. The steam cracking unit 80 may contact the light naphtha stream 14, the whole naphtha stream 15, or both with steam at the steam cracking temperature to steam crack at least a portion of hydrocarbons in the light naphtha stream 14, the whole naphtha stream 15, or both to produce olefins, such as but not limited to ethylene, propylene, butenes, or combinations of these. The system 100 may achieve an olefin yield of from 45 mol. % to 55 mol. % per barrel of hydrocarbon feed 12 introduced to the ADU 10.

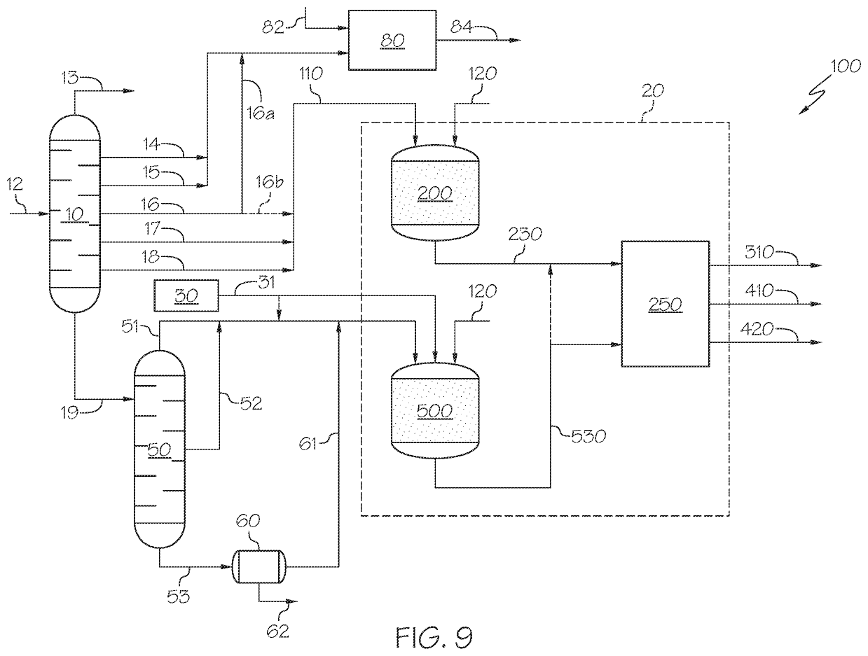

Referring now to FIG. 9, the system 100 may further include a gas condensate feed unit 30 upstream of the steam catalytic cracking system 20. The gas condensate feed unit 30 may be operable to pass a gas condensate 31 to the steam catalytic cracking system 20. The system 100 of FIG. 9 may also include the ADU 10, the VDU 50, the vacuum residue SDA unit 60, the steam cracking unit 80, and the steam catalytic cracking system 20, as previously described in relation to FIG. 8. Referring again to FIG. 9, the gas condensate feed unit 30 may be in fluid communication with the steam catalytic cracking system 20 to pass the gas condensate to the first steam catalytic cracking reactor 200, the second steam catalytic cracking reactor 500, or both. In embodiments, the gas condensate 31 may be passed to the second steam catalytic cracking reactor 500. The gas condensate feed unit 30 may be in fluid communication with the second steam catalytic cracking reactor 500 to pass the gas condensate 31 directly to the second steam catalytic cracking reactor 500. The gas condensate feed unit 30 and gas condensate 31 may have any of the features or characteristics previously described in the present disclosure for the gas condensate feed unit 30 and gas condensate 31 in relation to FIG. 3.

In embodiments, the gas condensate 31 may be passed directly to the second steam catalytic cracking reactor 500. In embodiments, the gas condensate 31 may be combined with at least one of the light vacuum gas oil stream 51, the heavy vacuum gas oil stream 52, the deasphalted oil 61, or combinations of these upstream of the second steam catalytic cracking reactor 500. The gas condensate 31 may comprise from 5 wt. % to 50 wt. % of the hydrocarbons passed to the second steam catalytic cracking reactor 500, which may include the gas condensate 31, and one or more of the light vacuum gas oil stream 51, the heavy vacuum gas oil stream 52, the deasphalted oil 61, or combinations of these. In embodiments, the hydrocarbons passed to the second steam catalytic cracking reactor 500 may include from 10 wt. % to 50 wt. %, from 15 wt. % to 50 wt. %, from 20 wt. % to 50 wt. %, from 5 wt. % to 45 wt. %, from 5 wt. % to 40 wt. %, from 10 wt. % to 45 wt. %, from 10 wt. % to 40 wt. %, from 15 wt. % to 45 wt. %, or from 15 wt. % to 40 wt. % gas condensate 31 based on the total weight of the light vacuum gas oil stream 51, the heavy vacuum gas oil stream 52, the deasphalted oil 61, and the gas condensate 31 passed to the second steam catalytic cracking reactor 500.

Referring to FIG. 9, in operation of the system 100 for converting hydrocarbon feed 12 to olefins, the hydrocarbon feed 12 may be introduced to the ADU 10. The ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. The ADU 10 may be in fluid communication with the first steam catalytic cracking reactor 200. At least one of the heavy naphtha stream 16, the kerosene stream 17, the gas oil stream 18, or combinations of these may be passed to the first steam catalytic cracking reactor 200. The ADU 10 may be in fluid communication with the steam cracking unit 80. At least one of the light naphtha stream 14, the whole naphtha stream 15, the heavy naphtha stream 16, or combinations of these may be passed to the steam cracking unit 80. Passing the gas condensate 31 to the second steam catalytic cracking reactor 500 may allow for the heavy naphtha stream 16 to be passed to the first steam catalytic cracking unit 200, the steam cracking unit 80, or both. In embodiments, the heavy naphtha stream 16 may be divided into a first heavy naphtha stream 16a and a second heavy naphtha stream 16b. The first heavy naphtha stream 16a may be passed to the steam cracking unit 80 and the second heavy naphtha stream 16b may be passed to the first steam catalytic cracking reactor 200.

The atmospheric residue 19 may be passed to the VDU 50. The VDU 50 may separate the atmospheric residue 19 into the light vacuum gas oil stream 51, the heavy vacuum gas oil stream 52, the vacuum residue 53, or combinations of these. The light vacuum gas oil stream 51, the heavy vacuum gas oil stream 52, or both may be passed to the second steam catalytic cracking reactor 500. The vacuum residue 53 may be passed to the vacuum residue SDA unit 60, which may reduce the asphaltene content of vacuum residue 53 to produce the deasphalted oil 61 and the SDA residue 62, as previously discussed in the present disclosure. The deasphalted oil 61 may be passed to the second steam catalytic cracking reactor 500. The SDA residue 62 may be passed out of the system 100. The gas condensate 31 may also be passed to the second steam catalytic cracking reactor 500. The deasphalted oil 61, the gas condensate 91, or both may be passed directly to the second steam catalytic cracking reactor 500 or may be combined with the light vacuum gas oil stream 51 the heavy vacuum gas oil stream 52, or both upstream of the second steam catalytic cracking reactor 500. The mixture of the deasphalted oil 61, the gas condensate 91, the light vacuum gas oil stream 51, the heavy vacuum gas oil stream 52, or combinations of these may be passed to the second steam catalytic cracking reactor 500.

The first steam catalytic cracking reactor 200 may contact the kerosene stream 17, the gas oil stream 18, and, optionally, at least a portion of the heavy naphtha stream 16b with steam in the presence of the nano-zeolite cracking catalyst to steam catalytic crack at least a portion of the hydrocarbons in the kerosene stream 17, the gas oil stream 18, and the portion of the heavy naphtha stream 16b to produce olefins, such as but not limited to ethylene, propylene, butenes, or combinations of these. The second steam catalytic cracking reactor 500 may contact the gas condensate 31, the light vacuum gas oil stream 51, the heavy vacuum gas oil stream 52, the deasphalted oil 61, or combinations of these with steam in the presence of the nano-zeolite cracking catalyst to steam catalytic crack at least a portion of the hydrocarbons in the gas condensate 31, the light vacuum gas oil stream 51, the heavy vacuum gas oil stream 52, the deasphalted oil 61, or combinations of these to produce olefins, such as but not limited to ethylene, propylene, butenes, or combinations of these. The first steam catalytic cracking effluent 230 and the second steam catalytic cracking effluent 530 may be passed to the steam catalytic cracking effluent separation system 250 for separation into the gaseous effluent 310, the liquid hydrocarbon effluent 410, and the aqueous effluent 420. The steam cracking unit 80 may contact the light naphtha stream 14, the whole naphtha stream 15, and, optionally, at least a portion of the heavy naphtha stream 16a with steam at the steam cracking temperature to steam crack at least a portion of hydrocarbons in the light naphtha stream 14, the whole naphtha stream 15, and the portion of the heavy naphtha stream 16a to produce olefins, such as but not limited to ethylene, propylene, butenes, or combinations of these. The system 100 depicted in FIG. 9 may achieve an olefin yield f from 45 mol. % to 55 mol. % olefins per barrel of hydrocarbon feed 12 introduced to the ADU 10.

Referring back to FIGS. 1 and 2, a process for converting the hydrocarbon feed 12 to olefins may include separating the hydrocarbon feed through the distillation system to produce the light gas stream 13, the plurality of distillate fractions 14, 15, 16, 17, 18, and the atmospheric residue 19. The hydrocarbon feed 12 may be introduced to the ADU 10. The ADU 10 may separate the hydrocarbon feed 12 into at least the light gas stream 13, the light naphtha stream 14, the whole naphtha stream 15, the heavy naphtha stream 16, the kerosene stream 17, the gas oil stream 18, the atmospheric residue 19, or combinations of these. The process may further include steam catalytic cracking at least one of the distillate fractions in the presence of steam and a nano-zeolite cracking catalyst disposed in at least one fixed bed steam catalytic cracking reactor 200 of the steam catalytic cracking system 20 to produce a steam cracking effluent 230 comprising olefins. The process may further include separating the steam catalytic cracking effluent 230 through the steam catalytic cracking effluent separation system 250 into one or more of ethylene, propylene, butene, or combinations of these. The steam catalytic cracking effluent separation system 250 may be disposed downstream of the steam catalytic cracking reactor 200. The process may achieve an olefin yield in mol. % of from 45 to 60%.

Referring again to FIG. 3, the process for converting the hydrocarbon feed 12 to olefins may further include passing the gas condensate 31 from gas condensate feed unit 30 to the steam catalytic cracking system 20, such as to the first steam catalytic cracking reactor 200 or the second steam catalytic cracking reactor 500 (FIG. 9). In embodiments, prior to introducing the gas condensate 31 to the at least one steam catalytic cracking reactor 200, 500 of the steam catalytic cracking system 20, the gas condensate 31 may be combined with at least one of the distillate fractions, such as one or more of the light naphtha stream 14, the whole naphtha stream 15, the heavy naphtha stream 16, the kerosene stream 17, and the gas oil stream 18, upstream of the steam catalytic cracking system 20. The gas condensate 31 and the at least one of the light naphtha stream 14, the whole naphtha stream 15, the heavy naphtha stream 16, the kerosene stream 17, the gas oil stream 18, or combinations of these may be passed to the steam catalytic cracking system 20. The steam catalytic cracking system 20 may steam catalytic crack the at least one of the gas condensate 31, the light naphtha stream 14, the whole naphtha stream 15, the heavy naphtha stream 16, the kerosene stream 17, the gas oil stream 18, or combinations of these in the presence of steam and the nano-zeolite cracking catalyst to produce olefins. The process may achieve an olefin yield in mol. % of from 45 to 60%.

Referring again to FIG. 4, the process for converting hydrocarbon feed 12 to olefins may further include deasphalting the atmospheric residue 19 through the SDA unit 40 to remove asphaltene compounds from the residue 19 to produce the deasphalted oil 41 and the DSA residue 42. The deasphalted oil 41 may be passed to the steam catalytic cracking system 20. The deasphalted oil 41 may be combined with at least one of the light naphtha stream 14, the whole naphtha stream 15, the heavy naphtha stream 16, the kerosene stream 17, the gas oil stream 18, or combinations of these upstream of the steam catalytic cracking system 20. The steam catalytic cracking system 20 may steam catalytic crack the at least one of the light naphtha stream 14, the whole naphtha stream 15, the heavy naphtha stream 16, the kerosene stream 17, the gas oil stream 18, the deasphalted oil 41, or combinations of these in the presence of steam and the nano-zeolite cracking catalyst to produce olefins. The process may achieve an olefin yield in mol. % of from 45 to 55%.

Referring again to FIG. 5, the process for converting the hydrocarbon feed 12 to olefins may further include passing the atmospheric residue 19 to the VDU 50 that separates the atmospheric residue 19 into at least one vacuum gas oil stream 51, 52 and a vacuum residue 53. The VDU 50 may separate the atmospheric residue 19 into the light vacuum gas oil stream 51, the heavy vacuum gas oil stream 52, the vacuum residue 53, or combinations of these. The process may further include passing the at least one of the light vacuum gas oil stream 51, the heavy vacuum gas oil stream 52, or both to the steam catalytic cracking system 20. The at least one of the light vacuum gas oil stream 51, the heavy vacuum gas oil stream 52, or both may be combined with at least one of the light naphtha stream 14, the whole naphtha stream 15, the heavy naphtha stream 16, the kerosene stream 17, the gas oil stream 18, or combinations of these upstream of the steam catalytic cracking system 20. The steam catalytic cracking system 20 may steam catalytic crack the at least one of the light naphtha stream 14, the whole naphtha stream 15, the heavy naphtha stream 16, the kerosene stream 17, the gas oil stream 18, light vacuum gas oil stream 51, the heavy vacuum gas oil stream 52, or combinations of these in the presence of steam and the nano-zeolite cracking catalyst to produce olefins. The process may achieve an olefin yield in mol. % of from 40 to 52%.

Referring again to FIG. 6, the process for converting the hydrocarbon feed 12 to olefins may further include deasphalting the vacuum residue 53 through the vacuum residue SDA unit 60 to remove at least a portion of the asphaltene compounds from the vacuum residue 53 to produce a deasphalted oil 61 and a SDA residue 62. The process may include passing the deasphalted oil 61 to the steam catalytic cracking system 20. The process may include passing the deasphalted oil 61 directly to the steam catalytic cracking system 20 or combining the deasphalted oil 61 with at least one of the light naphtha stream 14, the whole naphtha stream 15, the heavy naphtha stream 16, the kerosene stream 17, the gas oil stream 18, the light vacuum gas oil stream 51, the heavy vacuum gas oil stream 52, or combinations of these upstream of the steam catalytic cracking system 20. The steam catalytic cracking system 20 may steam catalytic crack the at least one of the light naphtha stream 14, the whole naphtha stream 15, the heavy naphtha stream 16, the kerosene stream 17, the gas oil stream 18, the light vacuum gas oil stream 51, the heavy vacuum gas oil stream 52, the deasphalted oil 61, or combinations of these in the presence of steam and the nano-zeolite cracking catalyst to produce olefins. The process may achieve an olefin yield in mol. % of from 45 to 55%.

Referring again to FIG. 7, the process for converting hydrocarbon feed 12 to olefins may further include passing one or more of the light naphtha stream 14, the whole naphtha stream 15, the kerosene stream 17, the gas oil stream 18, or combinations of these to the first steam catalytic cracking reactor 200, and steam catalytic cracking the one or more of the light naphtha stream 14, the whole naphtha stream 15, the kerosene stream 17, the gas oil stream 18, or combinations of these. The process may further include passing at least one of the light vacuum gas oil stream 51, the heavy vacuum gas oil stream 52, or both to the second steam catalytic cracking reactor 500. The second steam catalytic cracking reactor 500 may be operated in parallel to the first steam catalytic cracking reactor 200. The process may include combining at least one of the light vacuum gas oil stream 51, the heavy vacuum gas oil stream 52, or both may be combined with at least one of the heavy naphtha stream 16, the deasphalted oil 61, or both upstream of the second steam catalytic cracking reactor 500. The second steam catalytic cracking reactor 500 may steam catalytic crack the at least one of the heavy naphtha stream 16, the light vacuum gas oil stream 51, the heavy vacuum gas oil stream 52, the deasphalted oil 61, or combinations of these in the presence of steam and the nano-zeolite cracking catalyst to produce olefins. The process may achieve an olefin yield in mol. % of from 45 to 55%.

Referring again to FIG. 8, the process for converting the hydrocarbon feed 12 to olefins may further include passing at least one naphtha stream, such as the light naphtha 14, the whole naphtha 15, the heavy naphtha 16, or combinations of these, to a steam cracking unit 80 operated in parallel to the steam catalytic cracking system 20. The steam cracking unit 80 may not include a catalyst. The process may further include contacting the at least one of the light naphtha 14, the whole naphtha 15, he heavy naphtha 16, or combinations of these with steam in the steam cracking unit 80 at a steam cracking temperature, where the contacting may cause at least a portion of the hydrocarbons in the at least one of the light naphtha 14, the whole naphtha 15, the heavy naphtha 16, or combinations of these to undergo cracking reactions to produce a steam cracking effluent 84 comprising olefins. The process may include passing the kerosene stream 17, the gas oil stream 18, or both to the first steam catalytic cracking reactor 200. The first steam catalytic cracking reactor 200 may steam catalytic crack the at least one of the kerosene stream 17, the gas oil stream 18, or both in the presence of steam and the nano-zeolite cracking catalyst to produce olefins. The process may include passing the heavy naphtha stream 16 to the second steam catalytic cracking reactor 500. The process may further include passing the light vacuum gas oil stream 51, the heavy vacuum gas oil stream 52, or both from the VDU 50 to the second steam catalytic cracking reactor 500. The process may further include passing the deasphalted oil 61 from the vacuum residue SDA unit 60 to the second steam catalytic cracking reactor 500. The steam catalytic cracking reactor 500 may steam catalytic crack the at least one of the heavy naphtha stream 16, the light vacuum gas oil stream 51, the heavy vacuum gas oil stream 52, and the deasphalted oil 61 in the presence of steam and the nano-zeolite cracking catalyst to produce olefins. The process may achieve an olefin yield in mol. % of from 45 to 55%.

Referring again to FIG. 9, the process for converting the hydrocarbon feed 12 to olefins may further include introducing a gas condensate 31 from a gas condensate feed unit 30 to the second steam catalytic cracking reactor 500. The process may include combining the gas condensate 31 with at least one of at least one of the light vacuum gas oil stream 51, the heavy vacuum gas oil stream 52, the deasphalted oil 61, or combinations of these upstream of the at least one fixed bed steam catalytic cracking reactor 70. The process may include passing the heavy naphtha stream 16 to the steam catalytic cracking unit 80, the first steam catalytic cracking reactor 200, or both. The first steam catalytic cracking reactor 20 may steam catalytic crack the at least one of the, the kerosene stream 17, the gas oil stream 18, optionally the second heavy naphtha stream 16b, or combinations of these in the presence of steam and the nano-zeolite cracking catalyst to produce olefins. The second steam catalytic cracking reactor 500 may steam catalytic crack the at least one of the light vacuum gas oil stream 51, the heavy vacuum gas oil stream 52, the deasphalted oil 61, the gas condensate 91, or combinations of these in the presence of steam and the nano-zeolite cracking catalyst to produce olefins. The steam cracking unit 80 may steam crack the at least one of the light naphtha stream 14, the whole naphtha stream 15, a portion of the heavy naphtha stream 16a, or combinations of these without a catalyst to produce olefins. The process may achieve an olefin yield in mol. % of from 45 to 55%.

### EXAMPLES

The various embodiments of methods and systems for the processing of a hydrocarbon feed to produce olefins will be further clarified by the following examples. The examples are illustrative in nature, and should not be understood to limit the subject matter of the present disclosure.

### Example 1: Converting Whole Crude Oil to Olefins

Example 1 was conducted at a pilot plant having the configuration and characteristics of the system 1 illustrated in FIG. 1. In Example 1, the steam catalytic cracking system was utilized to convert distillate fractions obtained from a crude oil with an API gravity of 32 to olefins. A crude oil was distilled through atmospheric and vacuum distillation, and the distillation fractions included naphtha, kerosene, gas oil, and vacuum gas oil (boiling points 200° F. to 1050° F.) were obtained.

The distillation fractions (naphtha, kerosene, gas oil, vacuum gas oil) were passed to a fixed bed steam catalytic cracking reactor. The distillation fractions were preheated and the pre-heated feed at 100° C. was introduced to the reactor at space velocity of 1 hourly (h⁻¹) and steam was injected at space velocity of 3 hourly (h⁻¹). The steam to oil mass ratio was 3:1. The steam catalytic cracking was carried out in the reactor loaded with nano ZSM-5 zeolite bounded with 40 wt. % alumina binder. The zeolite powder had a crystal size ranging between 100 to 500 nm. The reactor was operated at 600° C.±10° C. The conversion process was conducted for 260 minutes on stream as one conversion cycle. The gas yield was analyzed every 30 minutes until final time of operation at 260 minutes. The high yield of olefins from 58 to 62% was achieved per every 30 minutes. The average of gas yield are listed in Table 2.

As shown in Table 2, the nano zeolite steam catalytic cracking process of distillation fraction achieved high conversion. High yield of olefins 60.5% with propylene/ethylene ratio of approximately 1.9 was obtained. Moreover, the process produced surplus of hydrogen (approximately 6.5%), NGL+ethane (approximately 3.5%) and 7% naphtha.

TABLE 2
Composition of steam catalytic cracking effluent from Example 1

| | Example 1 |
|---|---|
| Constituent | Yield (wt. %) |
| Naphtha | 7 |
| Kerosene | 3.9 |
| Diesel | 8.8 |
| VGO | 2.9 |
| Olefins | 60.5 |
| Ethylene | 16.3 |
| Propylene | 30.4 |
| Butenes | 13.8 |
| P/E | 1.9 |
| H₂ | 6.5 |
| Methane | 5.1 |
| NGL + Ethane gas | 3.5 |
| Coke | 1.8 |

### Example 2: Converting Whole Crude Oil to Olefins

Example 2 was conducted at a pilot plant having the configuration and characteristics of the system illustrated in FIG. 6. In Example 2, the vacuum residue from the VDU unit sent to the SDA unit. Then the deasphalted oil from the SDA unit mixed with 20 wt. % heavy naphtha from the ADU. Then the mixture of the deasphalted oil and heavy naphtha sent to the steam catalytic cracking system and tested by using the same reactor and condition of Example 1 (at space velocity of 1 hourly (h⁻¹) but steam was injected at space velocity of 2 hourly (h⁻¹). The average of gas yield are listed in Table 3.

### Comparative Example 3

Comparative example 3 was conducted at the same pilot plant having the configuration and characteristics of the system illustrated in Example 2, but the steam was not injected. The average of gas yield are listed in Table 3.

TABLE 3
Composition of steam catalytic cracking effluent
from Example 2 and Comparative Example 3

| | Example 12 | Comparative Example 3 |
|---|---|---|
| Constituent | Yield (wt. %) | Yield (wt.) |
| Naphtha | 7.6 | 16.3 |
| Kerosene | 5.5 | 8.2 |
| Diesel | 5.8 | 8.4 |
| VGO | 17.1 | 22.1 |
| Olefins | 41.5 | 23.8 |
| Ethylene | 11.9 | 9.8 |
| Propylene | 20.2 | 10.6 |
| Butenes | 9.4 | 3.4 |
| P/E | 1.7 | 1.1 |
| H₂ | 5.7 | 3.6 |
| Methane | 7.9 | 8.2 |
| NGL + Ethane gas | 5 | 4.8 |
| Coke | 3.9 | 4.6 |

### Comparison of Example 2 and Comparative Example 3

As shown in Table 3, the Example 2 process achieved high conversion. Comparing the process of Example 2 to the process of Comparative Example 3, the process of Example 2 enables more efficient conversion of whole crude oil to olefins (41.5 wt. % yield of olefins vs 23.8 wt. % yield of olefin).

A first aspect of the present disclosure is directed to a process for converting a hydrocarbon feed to olefins that may include separating the hydrocarbon feed through a distillation system to produce a light gas stream, a plurality of distillate fractions, and a residue; and steam catalytic cracking at least one of the distillate fractions in the presence of steam and a nano-zeolite cracking catalyst disposed in at least one steam catalytic cracking reactor to produce a steam catalytic cracking effluent comprising olefins, where the steam catalytic cracking reactor may be a fixed bed reactor.

A second aspect of the present disclosure may be directed to a process for converting a hydrocarbon feed to olefins, the process comprising passing the hydrocarbon feed to a distillation system to separate the hydrocarbon feed to produce a light gas stream, a plurality of distillate fractions, and a residue and passing at least one distillate fraction of the plurality of distillate fractions to a steam catalytic cracking system comprising at least one steam catalytic cracking reactor that may be a fixed bed reactor containing a nano-zeolite cracking catalyst. The steam catalytic cracking system may contact the one or more of the plurality of distillate fractions with steam in the presence of the nano-zeolite cracking catalyst to cause steam catalytic cracking of at least a portion of hydrocarbons in the at least one distillate fraction to produce a steam catalytic cracking effluent comprising olefins.

A third aspect of the present disclosure may include either one of the first or second aspects, where the hydrocarbon feed may comprise a whole crude oil having an API gravity between 25 and 50.

A fourth aspect of the present disclosure may include any one of the first through third aspects, where steam catalytic cracking the at least one distillate fraction may be conducted at a reaction temperature of from 550° C. to 750° C.

A fifth aspect of the present disclosure may include any one of the first through fourth aspects, where the olefins may include ethylene, propylene, butene, or combinations of these.

A sixth aspect of the present disclosure may include any one of the first through fifth aspects, where an olefin yield from the process may be from 30 mol. % to 60 mol. %.

A seventh aspect of the present disclosure may include the sixth aspect, further comprising: deasphalting the residue to remove asphaltene compounds from the residue to produce a deasphalted oil, passing the deasphalted oil to the fixed bed steam catalytic cracking reactor, and steam catalytic cracking the deasphalted oil.

An eighth aspect of the present disclosure may include any one of the first through seventh aspects, further comprising introducing a gas condensate to the at least one steam catalytic cracking reactor.

A ninth aspect of the present disclosure may include the eighth aspect, further comprising combining the gas condensate with at least one of the distillate fractions upstream of the at least one steam catalytic cracking reactor, where the content of the gas condensate may be from 5 weight percent to 50 weight percent of total hydrocarbons passed to the at least one steam catalytic cracking reactor.

A tenth aspect of the present disclosure may include any one of the first through ninth aspects, where the plurality of distillate fractions may comprise one or more of a light naphtha stream, a whole naphtha stream, a heavy naphtha stream, a kerosene stream, a gas oil stream, a light vacuum gas oil stream, a heavy vacuum gas oil stream, or combinations of these.

An eleventh aspect of the present disclosure may include any one of the first through tenth aspects, where the at least one steam catalytic cracking reactor may comprise a first steam catalytic cracking reactor and a second steam catalytic cracking reactor in parallel with the first steam catalytic cracking reactor and the process may further comprise passing one or more of the light naphtha stream, the whole naphtha stream, the heavy naphtha stream, the kerosene stream, the gas oil stream, or combinations of these to the first steam catalytic cracking reactor; steam catalytic cracking the one or more of the light naphtha stream, the whole naphtha stream, the heavy naphtha stream, the kerosene stream, the gas oil stream, or combinations of these in the first steam catalytic cracking reactor; passing at least one of the light vacuum gas oil, the heavy vacuum gas oil, or both to the second fixed bed steam catalytic cracking reactor; and steam catalytic cracking the at least one of the light vacuum gas oil, the heavy vacuum gas oil, or both in the second steam catalytic cracking reactor.

A twelfth aspect of the present disclosure may include any one of the first through eleventh aspects, further comprising passing at least one naphtha stream to a steam cracking unit operated in parallel with the at least one catalytic steam cracking reactor, where the steam cracking unit does not include a catalyst and the naphtha stream may comprise one or more of the light naphtha, the whole naphtha, the heavy naphtha, or combinations of these. The process may further include contacting the naphtha stream with steam in the steam cracking unit at a steam cracking temperature, where the contacting may cause at least a portion of the hydrocarbons in the naphtha stream to undergo cracking reactions to produce a steam cracking effluent comprising olefins.

A thirteenth aspect of the present disclosure may include any one of the first through twelfth aspects, where separating the hydrocarbon feed may comprise passing the hydrocarbon feed to an atmospheric distillation unit that may separate the hydrocarbon feed into the plurality of distillate fractions and the residue, where the residue is an atmospheric residue and the distillate fractions comprise one or more of a light naphtha stream, a whole naphtha stream, a heavy naphtha stream, a kerosene stream, a gas oil stream, or combinations of these.

A fourteenth aspect of the present disclosure may include the thirteenth aspect, further comprising passing the atmospheric residue to a vacuum distillation unit that separates the atmospheric residue into at least one vacuum gas oil stream and a vacuum residue.

A fifteenth aspect of the present disclosure may include the fourteenth aspect, further comprising passing the at least one vacuum gas oil stream to the at least one steam catalytic cracking reactor and steam catalytic cracking the at least one vacuum gas oil stream.

A sixteenth aspect of the present disclosure may include either one of the fourteenth or fifteenth aspects, further comprising deasphalting the vacuum residue to remove asphaltene compounds from the vacuum residue to produce a deasphalted oil, passing the deasphalted oil to the at least one steam catalytic cracking reactor, and steam catalytic cracking the deasphalted oil in the at least one steam catalytic cracking reactor.

A seventeenth aspect of the present disclosure may include any one of the fourteenth through sixteenth aspects, further comprising passing at least one naphtha stream to a steam cracking unit operated in parallel with the at least one steam catalytic cracking reactor, where the steam cracking unit does not include a catalyst and the naphtha stream may comprise one or more of the light naphtha, the whole naphtha, the heavy naphtha, or combinations of these. The process may further include contacting the naphtha stream with steam in the steam cracking unit at a steam cracking temperature, where the contacting may cause at least a portion of the hydrocarbons in the naphtha stream to undergo cracking reactions to produce a steam cracking effluent comprising olefins.

An eighteenth aspect of the present disclosure may include any one of the fourteenth through seventeenth aspects, where the at least one steam catalytic cracking reactor may comprise a first steam catalytic cracking reactor and a second steam catalytic cracking reactor in parallel with the first steam catalytic cracking reactor, and the process may further comprise passing one or more of the light naphtha stream, the whole naphtha stream, the heavy naphtha stream, the kerosene stream, the gas oil stream, or combinations of these to the first steam catalytic cracking reactor; steam catalytic cracking the one or more of the light naphtha stream, the whole naphtha stream, the heavy naphtha stream, the kerosene stream, the gas oil stream, or combinations of these in the first steam catalytic cracking reactor; passing at least one vacuum gas oil stream to the second steam catalytic cracking reactor; and steam catalytic cracking the at least one vacuum gas oil stream in the second steam catalytic cracking reactor.

A nineteenth aspect of the present disclosure may include the eighteenth aspect, further comprising introducing a gas condensate to the second steam catalytic cracking reactor.

A twentieth aspect of the present disclosure may include the nineteenth aspect, further comprising combining the gas condensate with at least one vacuum gas oil stream upstream of the second steam catalytic cracking reactor, where the content of the gas condensate may be from 5 weight percent to 50 weight percent of total hydrocarbons passed to the second steam catalytic cracking reactor.

A twenty-first aspect of the present disclosure may include any one of the first through twentieth aspects, further comprising separating the steam catalytic cracking effluent into one or more of ethylene, propylene, butene, or combinations of these.

A twenty-second aspect of the present disclosure may include any one of the first through twenty-first aspects, where the nano-zeolite cracking catalyst may comprise nano ZSM-5 zeolite, nano BEA zeolite, or both.

A twenty-third aspect of the present disclosure may include any one of the first through twenty-second aspects, where the nano-zeolite cracking catalyst may have a molar ratio of silica to alumina of from 10 to 200.

A twenty-fourth aspect of the present disclosure may include any one of the first through twenty-third aspects, where a crystal size of the nano-zeolite cracking catalyst may be from 50 nm to 600 nm.

A twenty-fifth aspect of the present disclosure may be directed to a system for converting a hydrocarbon feed to olefins. The system may include a distillation system that may be operable to separate the hydrocarbon feed to produce a light gas stream, a plurality of distillate fractions, and a residue and a steam catalytic cracking system downstream of the distillation system. The steam catalytic cracking system may comprise at least one steam catalytic cracking reactor that may be a fixed bed reactor comprising a nano-zeolite cracking catalyst, where the at least one steam catalytic cracking reactor may be operable to contact one or more of the distillate fractions with steam in the presence of the nano-zeolite cracking catalyst to produce a steam cracking effluent comprising olefins.

A twenty-sixth aspect of the present disclosure may include the twenty-fifth aspect, further comprising a steam catalytic cracking effluent separation system downstream of the at least one steam catalytic cracking reactor. The steam catalytic cracking effluent separation system may be operable to separate the steam catalytic cracking effluent into a gaseous effluent comprising olefins, a hydrocarbon liquid effluent, and an aqueous effluent.

A twenty-seventh aspect of the present disclosure may include either one of the twenty-fifth or twenty-sixth aspects, where the hydrocarbon feed may comprise a whole crude oil having an API gravity between 25 and 50.

A twenty-eighth aspect of the present disclosure may include any one of the twenty-fifth through twenty-seventh aspects, where the steam catalytic cracking system may be operated at a reaction temperature of from 550° C. to 750° C.

A twenty-ninth aspect of the present disclosure may include any one of the twenty-fifth through twenty-eighth aspects, where the nano-zeolite cracking catalyst may comprise nano ZSM-5 zeolite, nano BEA zeolite, or both.

A thirtieth aspect of the present disclosure may include any one of the twenty-fifth through twenty-ninth aspects, where the nano-zeolite cracking catalyst may have a silica to alumina molar ratio from 10 to 200.

A thirty-first aspect of the present disclosure may include any one of the twenty-fifth through thirtieth aspects, where a crystal size of the nano-zeolite cracking catalyst may be from 50 nm to 600 nm.

A thirty-second aspect of the present disclosure may include any one of the twenty-fifth through thirty-first aspects, where the olefins may be selected from the group consisting of ethylene, propylene, butene, and combinations of these.

A thirty-third aspect of the present disclosure may include any one of the twenty-fifth through thirty-second aspects, where an olefin yield from the system may be from 30 mol. % to 60 mol. %.

A thirty-fourth aspect of the present disclosure may include any one of the twenty-fifth through thirty-third aspects, further comprising a Solvent Deasphalting (SDA) unit downstream of the distillation system. The SDA unit may be operable to remove asphaltene compounds from the residue to produce a deasphalted oil, where the SDA unit may be in fluid communication with the at least one steam catalytic cracking reactor to pass the deasphalted oil to the at least one steam catalytic cracking reactor.

A thirty-fifth aspect of the present disclosure may include any one of the twenty-fifth through thirty-fourth aspects, further comprising a gas condensate feed unit upstream of the steam catalytic cracking system. The gas plant may be operable to introduce a gas condensate to the at least one steam catalytic cracking reactor.

A thirty-sixth aspect of the present disclosure may include any one of the twenty-fifth through thirty-fifth aspects, where the distillation system may comprise an atmospheric distillation unit operable to separate the hydrocarbon feed into the plurality of distillate fractions and the residue, where the residue may be an atmospheric residue and the distillate fractions may comprise one or more of a light naphtha stream, a whole naphtha stream, a heavy naphtha stream, a kerosene stream, a gas oil stream, or combinations of these. The distillation system may include a vacuum distillation unit downstream of the atmospheric distillation unit. The vacuum distillation unit may be operable to separate the atmospheric residue into at least one vacuum gas oil stream and a vacuum residue.

A thirty-seventh aspect of the present disclosure may include the thirty-sixth aspect, where the vacuum distillation unit may be in fluid communication with the at least one steam catalytic cracking reactor to pass at the least one vacuum gas oil stream to the at least one steam catalytic cracking reactor.

A thirty-eighth aspect of the present disclosure may include any one of the twenty-fifth through thirty-seventh aspects, where the steam catalytic cracking system may comprise a first steam catalytic cracking reactor and a second steam catalytic cracking reactor, which may be operated in parallel with the first steam catalytic cracking reactor. The first steam catalytic cracking reactor and the second steam catalytic cracking reactor may be fixed bed reactors.

A thirty-ninth aspect of the present disclosure may include any one of the twenty-fifth through thirty-eighth aspects, further comprising a steam cracking unit downstream of the distillation system and in parallel with the steam catalytic cracking system. The steam cracking unit may be operable to crack at least one of the distillate fractions.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

1. A process for converting a hydrocarbon feed to olefins, the process comprising:
separating the hydrocarbon feed through a distillation system to produce a light gas stream, a plurality of distillate fractions, and a residue;
passing at least one of the plurality of distillate fractions from the distillation system directly to a steam catalytic cracking reactor; and
steam catalytic cracking at least one of the distillate fractions in the presence of steam and a nano-zeolite cracking catalyst disposed in at least one steam catalytic cracking reactor to produce a steam catalytic cracking effluent comprising the olefins, where the steam catalytic cracking reactor is a fixed bed reactor.

2. The process of claim 1, where the hydrocarbon feed comprises a whole crude oil having an API gravity between 25 and 50 and the olefins comprise ethylene, propylene, butene, or combinations of these.

3. The process of claim 1, further comprising:
deasphalting the residue to remove asphaltene compounds from the residue to produce a deasphalted oil;
passing the deasphalted oil to the fixed bed steam catalytic cracking reactor; and
steam catalytic cracking the deasphalted oil.

4. The process of claim 1, further comprising introducing a gas condensate to the at least one steam catalytic cracking reactor.

5. The process of claim 4, further comprising combining the gas condensate with at least one of the distillate fractions upstream of the at least one steam catalytic cracking reactor, where the content of the gas condensate is from 5 weight percent to 50 weight percent of total hydrocarbons passed to the at least one steam catalytic cracking reactor.

6. The process of claim 1, where the plurality of distillate fractions comprise one or more of a light naphtha stream, a whole naphtha stream, a heavy naphtha stream, a kerosene stream, a gas oil stream, a light vacuum gas oil stream, a heavy vacuum gas oil stream, or combinations of these.

7. The process of claim 6, where the at least one steam catalytic cracking reactor comprises a first steam catalytic cracking reactor and a second steam catalytic cracking reactor in parallel with the first steam catalytic cracking reactor and the process further comprises:
passing one or more of the light naphtha stream, the whole naphtha stream, the heavy naphtha stream, the kerosene stream, the gas oil stream, or combinations of these to the first steam catalytic cracking reactor;
steam catalytic cracking the one or more of the light naphtha stream, the whole naphtha stream, the heavy naphtha stream, the kerosene stream, the gas oil stream, or combinations of these in the first steam catalytic cracking reactor;
passing at least one of the light vacuum gas oil, the heavy vacuum gas oil, or both to the second fixed bed steam catalytic cracking reactor; and
steam catalytic cracking the at least one of the light vacuum gas oil, the heavy vacuum gas oil, or both in the second steam catalytic cracking reactor.

8. The process of claim 6, further comprising:
passing at least one naphtha stream to a steam cracking unit operated in parallel with the at least one catalytic steam cracking reactor, where the steam cracking unit does not include a catalyst and the naphtha stream comprises one or more of the light naphtha, the whole naphtha, the heavy naphtha, or combinations of these; and
contacting the naphtha stream with steam in the steam cracking unit at a steam cracking temperature, where the contacting causes at least a portion of the hydrocarbons in the naphtha stream to undergo cracking reactions to produce a steam cracking effluent comprising the olefins.

9. The process of claim 1, where separating the hydrocarbon feed comprises passing the hydrocarbon feed to an atmospheric distillation unit that separates the hydrocarbon feed into the plurality of distillate fractions and the residue, where the residue is an atmospheric residue and the distillate fractions comprise one or more of a light naphtha stream, a whole naphtha stream, a heavy naphtha stream, a kerosene stream, a gas oil stream, or combinations of these.

10. The process of claim 9, further comprising passing the atmospheric residue to a vacuum distillation unit that separates the atmospheric residue into at least one vacuum gas oil stream and a vacuum residue.

11. The process of claim 10, further comprising:
passing the at least one vacuum gas oil stream to the at least one steam catalytic cracking reactor; and
steam catalytic cracking the at least one vacuum gas oil stream.

12. The process of claim 10, further comprising:
deasphalting the vacuum residue to remove asphaltene compounds from the vacuum residue to produce a deasphalted oil;
passing the deasphalted oil to the at least one steam catalytic cracking reactor; and
steam catalytic cracking the deasphalted oil in the at least one steam catalytic cracking reactor.

13. The process of claim 10, further comprising:
passing at least one naphtha stream to a steam cracking unit operated in parallel with the at least one steam catalytic cracking reactor, where the steam cracking unit does not include a catalyst and the naphtha stream comprises one or more of the light naphtha, the whole naphtha, the heavy naphtha, or combinations of these; and
contacting the naphtha stream with steam in the steam cracking unit at a steam cracking temperature, where the contacting causes at least a portion of the hydrocarbons in the naphtha stream to undergo cracking reactions to produce a steam cracking effluent comprising the olefins.

14. The process of claim 10, where the at least one steam catalytic cracking reactor comprises a first steam catalytic cracking reactor and a second steam catalytic cracking reactor in parallel with the first steam catalytic cracking reactor and the process further comprises:
passing one or more of the light naphtha stream, the whole naphtha stream, the heavy naphtha stream, the kerosene stream, the gas oil stream, or combinations of these to the first steam catalytic cracking reactor;
steam catalytic cracking the one or more of the light naphtha stream, the whole naphtha stream, the heavy naphtha stream, the kerosene stream, the gas oil stream, or combinations of these in the first steam catalytic cracking reactor;
passing at least one vacuum gas oil stream to the second steam catalytic cracking reactor; and
steam catalytic cracking the at least one vacuum gas oil stream in the second steam catalytic cracking reactor.

15. The process of claim 14, further comprising introducing a gas condensate to the second steam catalytic cracking reactor.

16. A system for converting a hydrocarbon feed to olefins, the system comprising:
a distillation system operable to separate the hydrocarbon feed to produce a light gas stream, a plurality of distillate fractions, and a residue; and
a steam catalytic cracking system downstream of the distillation system, the steam catalytic cracking system comprising at least one steam catalytic cracking reactor that is a fixed bed reactor comprising a nano-zeolite cracking catalyst, where the at least one steam catalytic cracking reactor is operable to contact one or more of the distillate fractions with steam in the presence of the nano-zeolite cracking catalyst to produce a steam cracking effluent comprising the olefins.

17. The system of claim 16, further comprising:
a Solvent Deasphalting (SDA) unit downstream of the distillation system, the SDA unit operable to remove asphaltene compounds from the residue to produce a deasphalted oil, where the SDA unit is in fluid communication with the at least one steam catalytic cracking reactor to pass the deasphalted oil to the at least one steam catalytic cracking reactor.

18. The system of claim 16, where the distillation system comprises:
an atmospheric distillation unit operable to separate the hydrocarbon feed into the plurality of distillate fractions and the residue, where the residue is an atmospheric residue and the distillate fractions comprise one or more of a light naphtha stream, a whole naphtha stream, a heavy naphtha stream, a kerosene stream, a gas oil stream, or combinations of these; and
a vacuum distillation unit downstream of the atmospheric distillation unit, the vacuum distillation unit operable to separate the atmospheric residue into at least one vacuum gas oil stream and a vacuum residue, wherein the vacuum distillation unit is in fluid communication with the at least one steam catalytic cracking reactor to pass at the least one vacuum gas oil stream to the at least one steam catalytic cracking reactor.

19. The system of claim 18, where the steam catalytic cracking system comprises:
a first steam catalytic cracking reactor; and
a second steam catalytic cracking reactor operated in parallel with the first steam catalytic cracking reactor;
where the first steam catalytic cracking reactor and the second steam catalytic cracking reactor are fixed bed reactors.

20. The system of claim 16, further comprising a steam cracking unit downstream of the distillation system and in parallel with the steam catalytic cracking system, the steam cracking unit operable to crack at least one of the distillate fractions.
